(19) United States
(12) Patent Application Publication
(10) Pub. No.: US 2025/0379499 A1
(43) Pub. Date: Dec. 11, 2025

(54) HOMOPOLAR TYPE GENERATORS AND MOTORS

(71) Applicant: NextPower360 Co., Leicester, NC (US)

(72) Inventor: Benedetto Anthony IACOVELLI, Leicester, NC (US)

(21) Appl. No.: 19/234,884

(22) Filed: Jun. 11, 2025

Related U.S. Application Data
(60) Provisional application No. 63/658,491, filed on Jun. 11, 2024.

(51) Int. Cl. H02K 31/02; H02K 1/02; H02K 9/22; H02K 16/02

(52) U.S. Cl. CPC H02K 31/02; H02K 1/02; H02K 9/227; H02K 16/025

(57) ABSTRACT

A homopolar dynamoelectric machine includes stator layers spaced radially apart from one another to produce a magnetic field, at least one rotor layer provided adjacent to the stator layers, and rotatable through the magnetic field, and stationary contact rings located adjacent to two axial ends of the at least one rotor layer. The contact rings include angled contact portions or brushes to electrically contact the at least one rotor layer. Bridge connectors are provided to electrically connect ones of the stationary contact rings axially opposed to one another.

### CROSS-REFERENCE TO RELATED APPLICATIONS

The present application claims domestic priority to 63/658,491, filed on Jun. 11, 2024, the entire contents of which is hereby incorporated herein by reference.

### BACKGROUND OF THE INVENTION

### 1. Field of the Invention

The present invention relates to novel structures and systems for improvements to generators and motors. More specifically, the present invention relates to drum or disk homopolar machines which are able to be used to increase a power output per volume, field strength per magnet mass, and the voltage.

### 2. Description of the Related Art

The most commonly understood homopolar disk generator employs a disk spinning in, and at right angles to, a magnetic field. Often, that field is created by permanent magnets stationed on either side of the disc. Because of the Faraday paradox, the magnets can be stationary or spinning about the same axis as the disk and the unit still creates the same amount of power. Essentially the field can be thought of as stationary whether the magnets are stationary or spinning about their North/South axis.

From a physics standpoint, but for a single fatal flaw in the voltage to current ratio of the power output, homopolar electrical machines are nearly ideal for power production, low cost of manufacture, and operational reliability. The magnet poles are closer together, with a direct, straight flux path, creating a much stronger field. The field is perfectly oriented and does not bulge or cross-react as it does in conventional machines.

### SUMMARY OF THE INVENTION

To overcome the problems described above, example embodiments of the present invention provide new dynamoelectric motor and generator systems and structures that instantly and constantly adapt to the variability of an input or output rotational speed. There is no need for the heavy bulky and costly silicon steel laminations in many example embodiments of the present disclosure. The percent of the volume of the, for example, generator that is actively experiencing voltage induction is orders of magnitude higher than in conventional designs. The interaction between the rotor and the stationary magnetic field involves the entire rotor cutting all field lines simultaneously at any RPM above zero so that the generator starts creating power as soon as the rotor begins to move. The entire rotor is bathed in a perfectly ordered field such that the flux lines are always perpendicular to the rotor's motion. The rotor can be entirely immersed in this perfectly ordered, and very powerful field throughout its entire circumference, length and 360 degree rotation. No conventional generator comes close to these advantages.

According to an example embodiment of the present invention, a homopolar dynamoelectric machine includes stator layers spaced radially apart from one another to produce a magnetic field, at least one rotor layer provided adjacent to the stator layers, and rotatable through the magnetic field, and stationary contact rings located adjacent to two axial ends of the at least one rotor layer. The contact rings include angled contact portions or brushes to electrically contact the at least one rotor layer. Bridge connectors are provided to electrically connect ones of the stationary contact rings axially opposed to one another.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a cross section of a Faraday drum generator with the rotor immersed in the radial field and sandwiched between two stators according to an example embodiment of the present invention.

FIG. 2 shows a FEA diagram of a permanent magnet generator showing the longer flux path and smaller electroactive area represented by the paired circles.

FIG. 3a shows a drum homopolar machine according to an example embodiment of the present invention which is a hollow tube with an empty center.

FIG. 3b shows a drum homopolar machine including additional magnet layers and stator layers that function as additional generators according to an example embodiment of the present invention.

FIG. 4 shows an example embodiment of the present invention in which two thick magnets are divided longitudinally to create ½ size and ½ strength thinner magnets such that a same total space is divided into more magnet pairs with a total volume that remains unchanged.

FIG. 5 shows a drum homopolar machine according to an example embodiment of the present invention.

FIG. 6 shows another drum homopolar machine according to an example embodiment of the present invention.

FIG. 7 shows a drum homopolar machine according to an example embodiment of the present invention.

FIG. 8 shows an enlarged portion of the drum homopolar machine of FIG. 7.

FIG. 9 shows a stator of a drum homopolar machine according to an example embodiment of the present invention.

FIG. 10 shows an exploded cross-section of a motor or generator according to an example embodiment of the present invention.

FIG. 11 shows a cross-section of a drum homopolar machine according to an example embodiment of the present invention.

FIG. 12 shows a graph of a magnet force to thickness.

FIGS. 13-15 show graphs of magnetic properties of different materials.

FIG. 16 shows a BH curve of Ferrite Y30.

FIG. 17 shows a graph of magnetic properties of different materials.

FIG. 18 shows a graph of initial magnetization curves of different materials.

FIG. 19 shows graphs of magnetic properties of different materials.

FIGS. 20-22 show tables of properties of different magnetic materials.

FIG. 23 shows a table and graph of the amps inputted into a recent coil of an example embodiment of the present disclosure and the rotor field intensity in milliTeslas.

FIGS. 24-26 depict a COMSOL FEA analysis of an example embodiment of the present disclosure.

### DETAILED DESCRIPTION OF EXAMPLE EMBODIMENTS

Example embodiments of the present invention will now be described with reference to the Drawings.

Example embodiments of the present invention are usable for dynamoelectric machines including electric motor applications as well as generator applications (e.g., the example embodiments of the present invention are applicable for any type of dynamoelectric machine). For the purpose of this disclosure the focus will be on drum and disk type example embodiments of homopolar type generators and motors, but the principles apply to all homopolar/designs in ways that are clear to those skilled in the art.

The most commonly understood homopolar disk generator employs a disk spinning in, and at right angles to, a magnetic field. Often, that field is created by permanent magnets stationed on either side of the disc. Because of the Faraday paradox, the magnets can be stationary or spinning about the same axis as the disk and the unit still creates the same amount of power. Essentially the field can be thought of as stationary whether the magnets are stationary or spinning about their North/South axis.

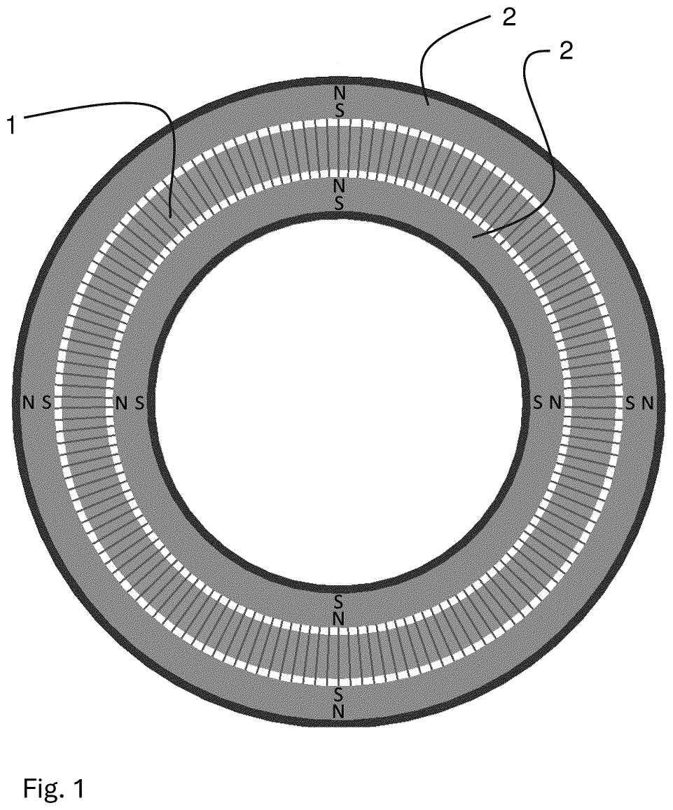

In the drum type arrangement, a conductive cylindrical drum serves as the rotor and it is most frequently concentrically sandwiched between radially magnetized larger and smaller diameter concentric cylindrical magnets. The cylindrical magnets create a radial field, in which the cylindrical rotor rotates. FIG. 1 shows a cross section of a Faraday drum generator according to an example embodiment of the present invention with the rotor 1 immersed in the radial field and sandwiched between 2 stators.

Just as in the disk variant, the same amount of power is generated in the drum type arrangement if the magnets of the stators 2 are stationary, or if the magnets and the stator 2 on which they are provided are rotating in place together with the rotor 1 around the longitudinal center axis of the drum. The same power output occurs because the magnetic field of the stator 2 functions as stationary magnetic field regardless of if the magnets of the stator 2 are rotating in the above manner or stationary. The rotor 2 physically rotates in the stationary magnetic field, transecting the flux, and creating EMF (Electro Magnetic Force).

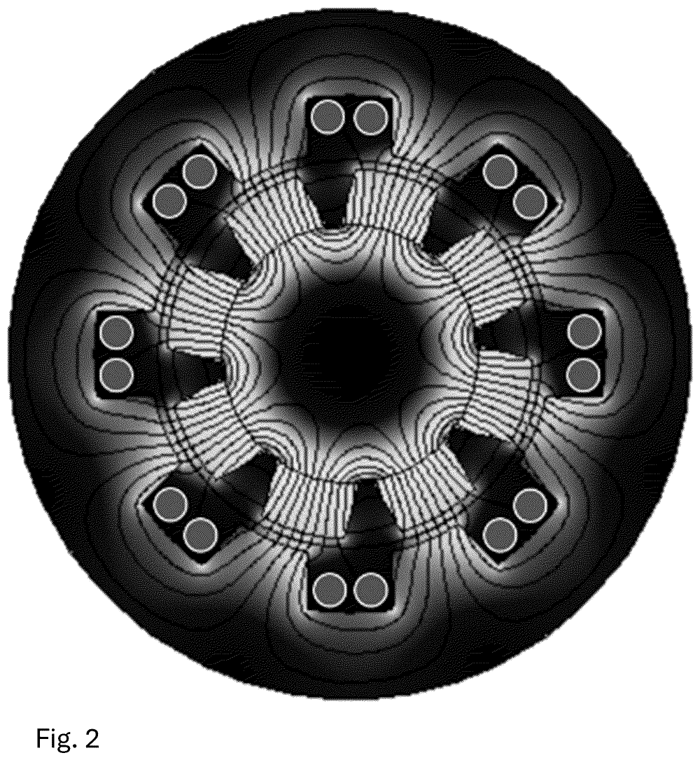

From a physics standpoint, but for a single fatal flaw regarding current and voltage power ratio (discussed in more detail below) which example embodiments of the present invention have overcome, homopolar electrical machines are nearly ideal for power production, low cost of manufacture, and operational reliability. The magnet poles are closer together, with a direct, straight flux path, creating a much stronger field. The field is perfectly oriented and does not bulge or cross-react as it does in conventional machines. There is no need for the heavy bulky and costly silicon steel laminations in many example embodiments of the present disclosure. The percent of the volume of the generator that is actively experiencing voltage induction is orders of magnitude higher than in conventional designs (an example of a conventional design being shown in FIG. 2).

In FIG. 2, all of the darker components are defined by thousands of stacked silicon steel laminations needed to conduct the magnetic flux in the generator. Silicon steel is heavy and accounts for more than half the weight of the generator as well as considerable cost and assembly complexity. As you can see in FIG. 1, structures according to the example embodiments of the present invention do not use any silicon steel. So half the weight is gone, doubling the power density to start with.

Further, magnetic field strength is generally dependent on the length of the flux path between the magnets making the field. As the distance the flux travels increases, the power in the field between them drops by the 3rd power of that distance. A generator's output depends on its field strength. As you can in FIGS. 1 and 2, before it can do any work, the flux in the conventional design of FIG. 2 travels around a looping path that is about 3 times as long as the flux path (extending radially straight) of that of the example embodiments of the present invention in FIG. 1. Conventional designs add the substantial weight, cost, and volume of silicon steel laminations to direct flux into smaller paths to partially atone for that problem.

In the conventional design, the only parts that actually make electricity are the solid gray colored paired circles. This represents about 1% of the weight and volume of the device. All the rest of the parts and materials are there to make and move the flux around. In example embodiments of the present invention, the entire central area is filled by the electroactive rotor 1. This is more than a 10-fold advantage that translates into a massive additional gain of power density. Put more simply, a lot more of the total volume of the same sized generator makes power in example embodiments of the present invention.

The conventional field constantly bulges, flairs, distorts, and twists stroboscopically as it moves. This represents an inefficient, cacophonous, disordered field. In fact, if you look closely in FIG. 2, most of the field lines aren't crossing the solid gray colored paired circles and the ones that do cross are actually moving backwards. Generators make electricity by passing field lines through metal, but conventional generators cannot do that consistently and constantly. Contrast that with the stationary, perfectly orderly, perfectly oriented field of the example embodiments of the present disclosure in FIG. 1. The rotor 1 spins in the perfectly ordered, ideally arranged radial field of the stators 2 shown as the radiating lines.

As the rotor 1 of FIG. 1 turns, it cuts in and ramps up much faster than conventional designs because its entire volume, throughout the full 360-degree revolution, cuts all the field lines of the stators 2 simultaneously and does so perpendicularly which is the most powerful way possible. Therefore, at a given RPM, the generator of the example embodiments of the present disclosure can make much more power per weight than a conventional design.

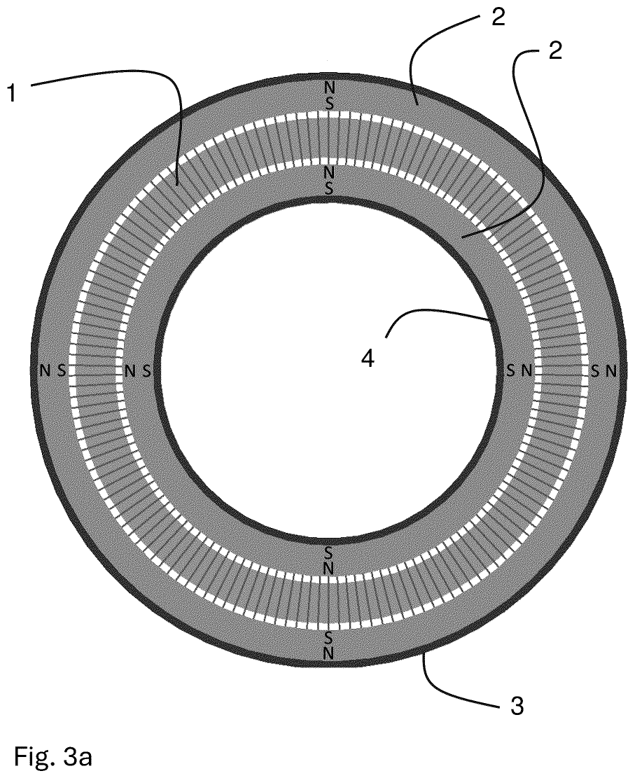

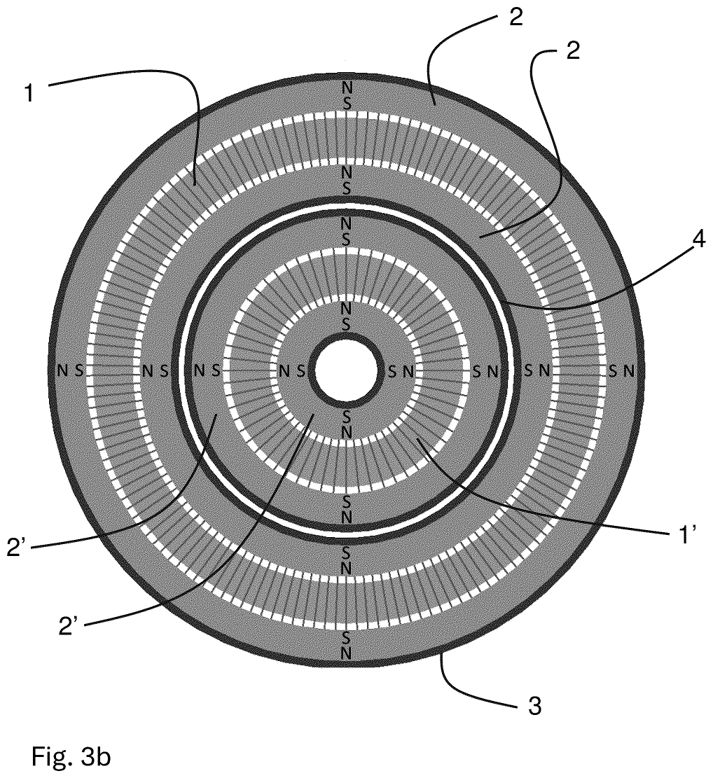

In a drum homopolar machine, because there is no need for the bulky laminations of silicon steel, the overall preferred morphology is often that of a hollow tube, for example. FIG. 3a shows a drum homopolar machine that is defined by a hollow tube 3 with an empty center 4. The overall cylinder wall in this case is preferably defined by one rotor layer 1 flanked by two stator layers 2. All the layers can be adhered together to rotate together monolithically, or could alternatively be provided separately with the rotor layer 1 rotating separately while the two stator layers 2 remain fixed, and the output is the same or substantially the same due to the Faraday Paradox as long as the rotor layer is rotating.

The hollow center 4 of the tube 3 can be filled by a second, smaller diameter drum homopolar machine, as shown in FIG. 3b. The hollow center can house additional rotor layers 1′ and stator layers 2′ that function as additional generators, for example. The additional generator can be structured to have an operating power generation range which peaks at a different RPM than that of the first generator creating adaptability to a wider range of RPMs. Also, now the magnets of each layer augment the field strength of the others.

If the magnet walls and rotor walls are made successively thinner, more and more layers of generators can be inserted into the system.

Further another example embodiment of the present disclosure corresponds to a dynamoelectric machine which includes a magnetic stator and a conducting rotor which are adhered to one another. As noted above, even when the stator rotates, the magnetic field of the stator still remains stationary due to the Faraday Paradox. Accordingly, the conducting rotor rotates through the stationary magnetic field to generate power.

Further, the magnetic stator itself may be made of a conductive magnet material which rotates through the stationary field. For example, a sintered Neodymium magnets could be used as the stator, with segmented components of a cylinder defining the stator being connected in series. With this arrangement, power is generated in both the rotor and the stator. For example, the conductive magnet material of the stator rotating through the fixed magnetic field produced by the stator will produce a separate power output from a power output produced by the conductive rotor. These two produced powers could be used for different applications, or could be combined through, for example, a transformer.

Because Faraday Drum structures of example embodiments of the present disclosure are a tubular cylinder with an open center:
a second smaller generator can be fit inside the first generator;
the rotor fills the radial field with mass;
the rotor mass is entirely electroactive;
as the rotor moves it cuts all the field lines simultaneously at any rpm above zero;
the rotor spin is always exactly perpendicular to the field lines so they are always cut at 90 degree angles throughout its entire volume and throughout the full 360 degree revolution;
there are no eddy currents;
there is no need for laminated steel so less parts, weight, cost and more of the generator volume is used specifically for making electricity; and
the rotor does not need to be pure copper as there are fewer eddy current problems.

Furthermore, as seen in FIG. 3b, because the homopolar disk generator is a hollow tubular shape, the inner empty area can host a second smaller generator, the output of which can be added to that first larger generator. Each individual generator assembly is lighter and more powerful, with a much higher power density than achieved in conventional designs, but then, we fit more generators in the same volume, further multiplying the already much better power density.

Conceptually, if the generators pictured in FIG. 3b were serially redesigned with successively thinner walls, then successively more generators could be layered into the center. When the various rotor layers are connected in series, the voltage adds at the proportional expense of the total potential amperage, creating an assembly with a higher voltage at the rotor. More on that as a way to solve a homopolar shortcoming after that shortcoming is described below.

The fatal flaw that caused homopolar development to be all but abandoned is that their output is almost entirely amperage and very little voltage. Conventional homopolar disks put out 125,000 Amps but only about 0.5 Volts. Power in this form is nearly useless. It does not transmit far enough, the amperage is deadly, and without voltage, almost no standard state of the art machines will work with it. It is good for niche applications such as rail guns and spot welders, but very little else. While step up transformers do exist, the efficiency losses from turning a fraction of a volt into the hundreds of thousands to millions that could be usable in a power grid are prohibitive.

Conventional generators have been developed from previous generator designs in which most of the ideal physics of the Faraday Drum were sacrificed to create a power generator that made a higher voltage, but massively less power. Understandably, the conventional generators sacrificed benefits of high specific energy, ideal field, ideal rotor, and simplicity to instead provide high voltage/low amperage output power that is more suitable for standard uses.

Another limitation to homopolar generators has been the need for sliding electrical contacts in harvesting the current from the rotor. The monolithic drum or disk rotor can sustain high rpm and deliver impressive energy from working in the steep portion of the exponential output curve. But at high rpm, sliding contacts lose efficiency and wear out faster. Researchers have tried several ways of getting around the need for sliding contacts.

One that has failed consistently is to hold the rotor stationary and spin the magnetic drums/disks. The idea being one could simply weld collecting contacts to the stationary rotor. That does not work because of the Faraday Paradox. The magnetic drums/disks rotate but their magnetic field does not. The rotor remains stationary in a stationary field.

The below described example embodiments of the present disclosure and improvements provided thereby are explained mainly for drum and disk variants, but the concepts can be applied to essentially all homopolar structures in manners reasonably clear to those skilled in the art.

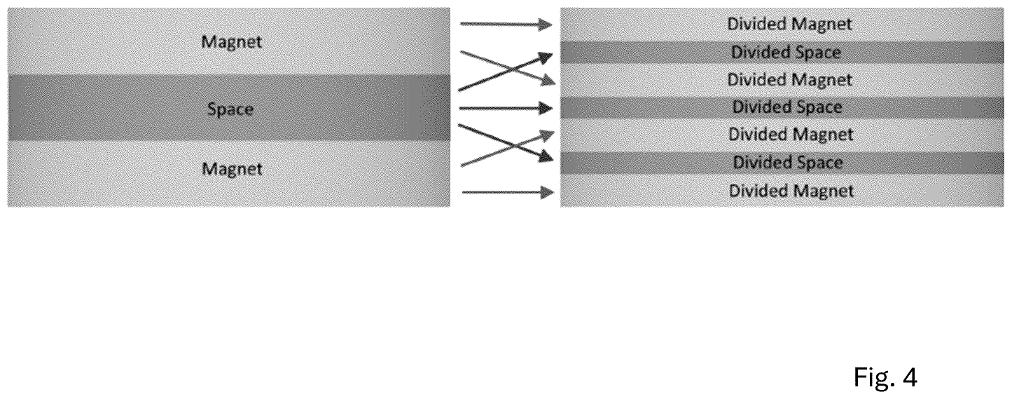

When a rotor is defined by a single monolithic member, the material therein can be considered to all be electrically connected in parallel, so the output has high amperage and low voltage. Dividing the rotor into electrically isolated segments and connecting those segments in series allows the output to be of higher voltage and lower amperage. The rotors can be segmented in many ways, an example of which is shown in FIG. 4.

The segments of the rotor can be interspersed between separate magnet layers or just immersed in a single field (e.g., segments of the rotor could be provided in a same circumferentially extending layer as the magnets defining the magnetic field).

For the purpose of this disclosure, we define a functional group as a “rotor” conductor portion with 2 corresponding “stator” magnet regions that supply a stationary magnetic field to the rotor space.

Generally, a generator in which the magnets and rotors can be thought of as divided into many layers can make more power than a generator made with the same total mass and average dimension of magnets and rotor arranged as a single functional group.

On the left in FIG. 4 are two magnets with larger length than height. Not pictured is flux return boxes respectively enclosing both sets of magnets and space. The flux return boxes are preferably identical or substantially identical. To the right of FIG. 4, each of the two original magnets were divided in half through their long axis. They are spaced so that the total distance between the four magnets is equal to the original distance between the two magnets. The total magnet mass and total volume is identical. Only the magnets have been divided into subsets interspersed with divided fractions of the rotor layer.

Even though the size of the system is the same, the total amount of space is the same, and the amount of magnet material is the same on both sides of FIG. 4, in the divided case on the right of FIG. 4 the flux density in the inter-magnet space is higher. This is because, even though each of the smaller magnets would generally have only about slightly more than half the original magnets' strength, the decreased space between the magnets increases the strength of the field in the inter-magnet space exponentially (3rd power). The net result of a half strength magnet but an exponentially greater field from greater magnet proximity is a net stronger field intensity between the magnets.

This confers an additional benefit to the generator/motor that is novel compared with conventional designs. There are many alternative ways that the rotor of a homopolar generator can be functionally or physically divided and connected in electrical series in accordance with example embodiments of the present disclosure.

For example, in a generator system according to example embodiments of the present disclosure, it is possible to channel flux from a centrally positioned magnet into flux manifold layers that are interspersed between conductive metal rotor layers. Whether in a serial disk configuration, a concentric drum configuration, or any other functionally similar configuration, an entirety of the power generating components of the device of example embodiments of the present disclosure including both “rotor” conductive portions and “stator” magnetic field components could be spun together while the field remained relatively stationary due to the Faraday paradox. This allows the rotor layers to rotate through the stationary field created in, and/or transmitted into place by the stator layers—also called flux manifold layers. Further, additional adaptability can be created by creating additional layers of different lengths or circumferences.

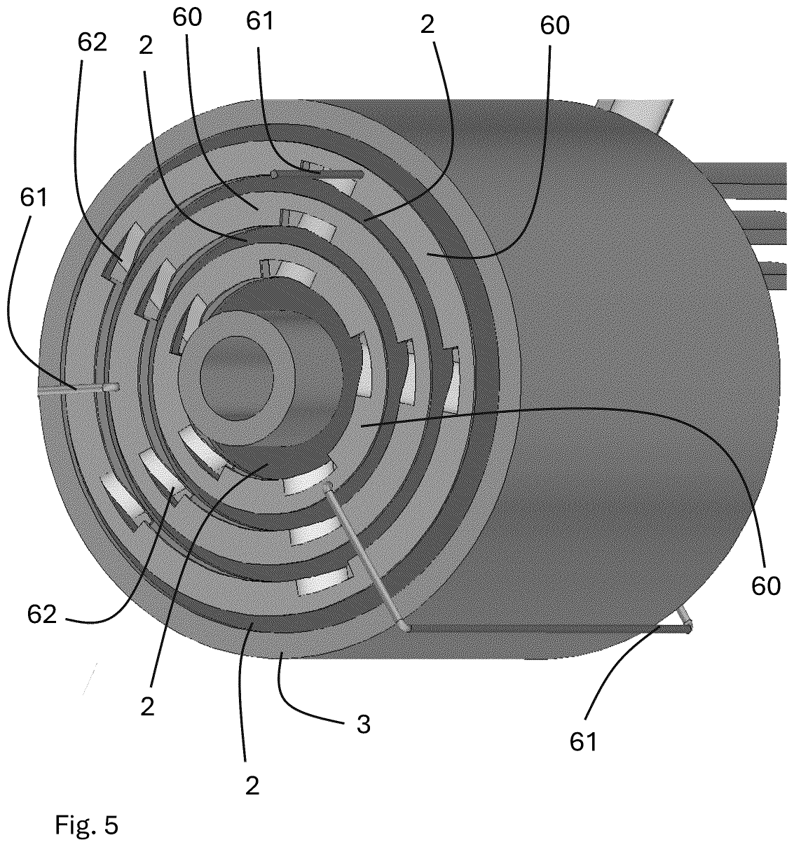

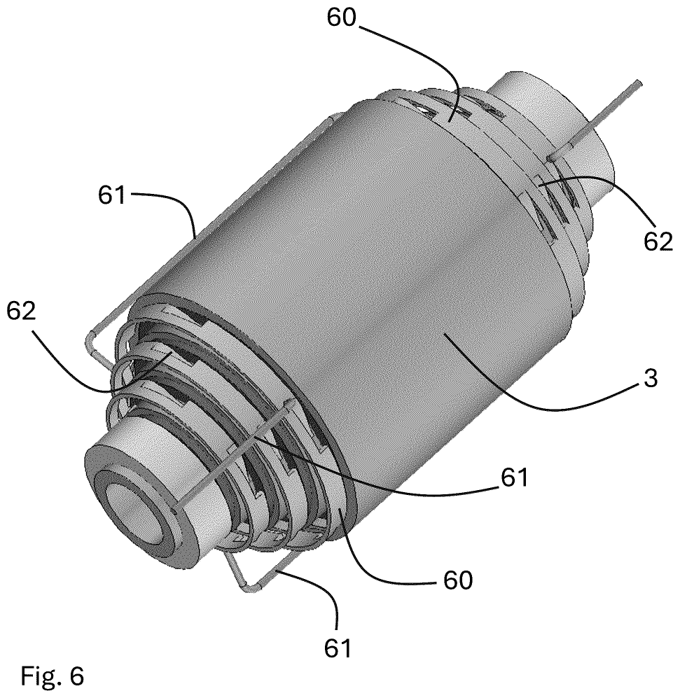

FIGS. 5 and 6 show example embodiments of the present disclosure in which stationary contact rings 60 that electrically contact and take power from each rotor 1 are provided on opposing axial ends of a generator. The stationary contact rings 60 on both opposing axial ends of the generator are preferably connected in series with similar contacts on the other side through bridge connectors 61. There is preferably one pair of contact rings 60 for each rotor ring, for example. The stationary contact rings 60 preferably include, for example, angled contact portions or brushes 62 which electrically contact the rotating rotor portions. As shown in FIG. 6, different rotor layers may have different axial dimensions.

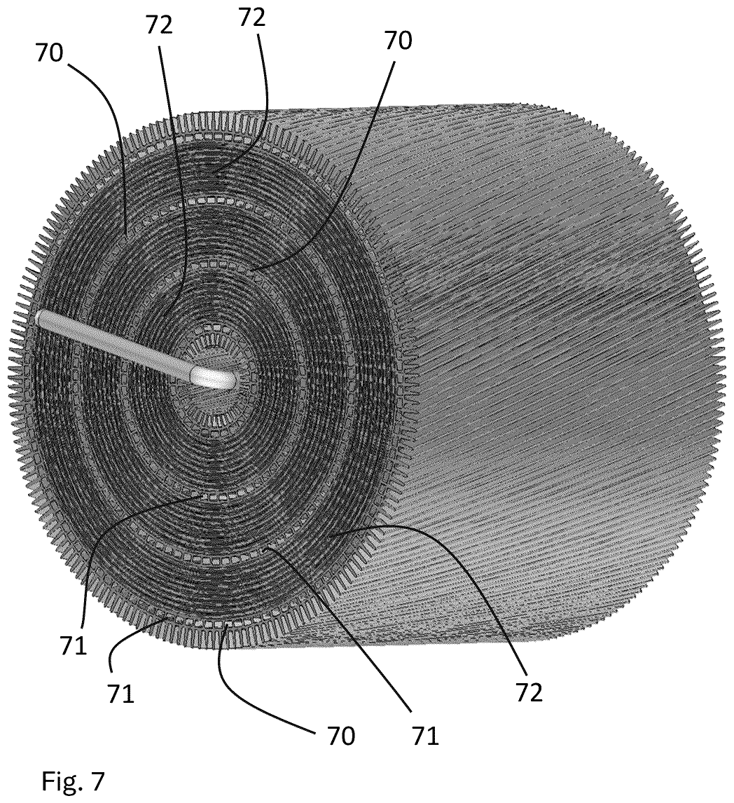

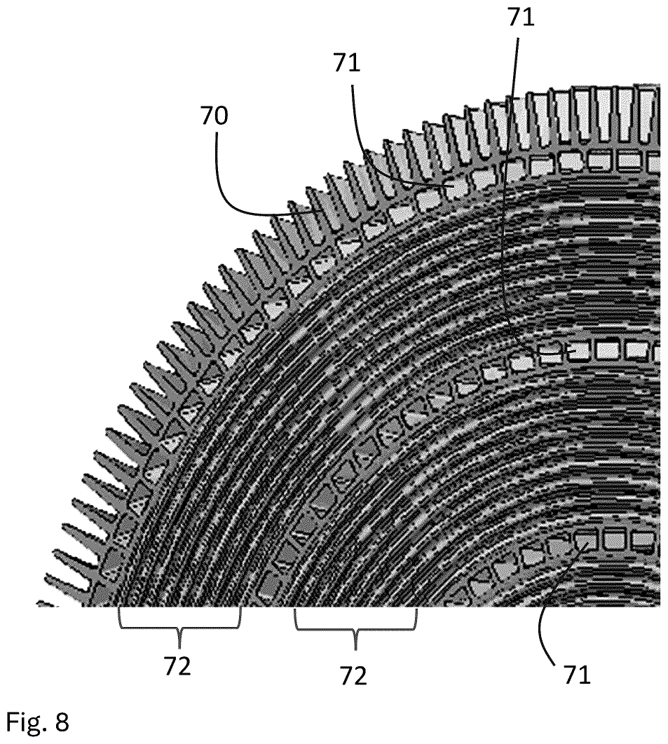

FIGS. 7 and 8 show an example embodiment of the present disclosure in which support frames 70 including cooling channels 71 may be provided to a generator or motor. The support frames 70 are preferably located between groupings 72 of stator and rotor portions. Inner and outermost ones of the support frames 70 preferably include fins on exposed surfaces to further aid in cooling efficiency.

The layered structure of FIGS. 7 and 8 lends itself to 3D printing and other inexpensive manufacturing techniques. Note that the coolant channels 71 may be skewed in a same or similar manner to the fins of the support frames 70 so that the Coriolis effect and/or changes in speed helps move coolant through the coolant channels 71.

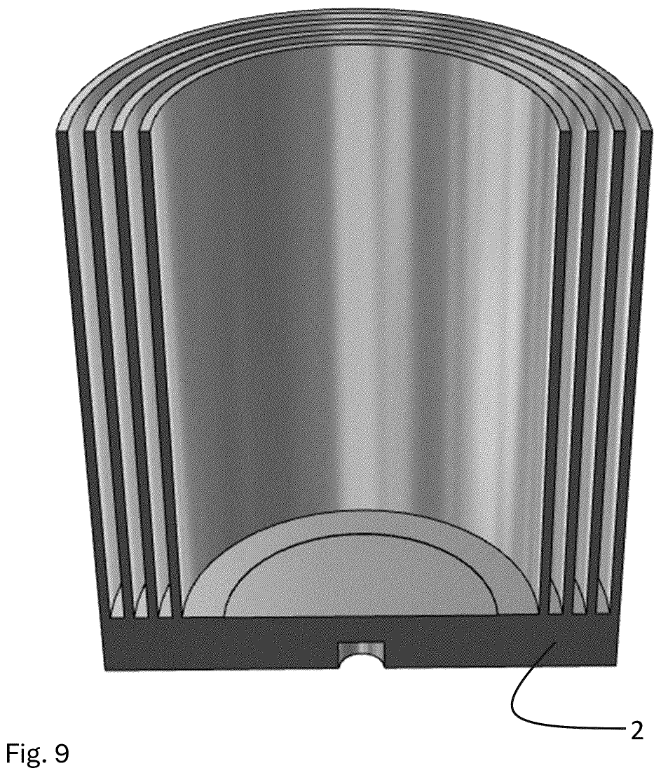

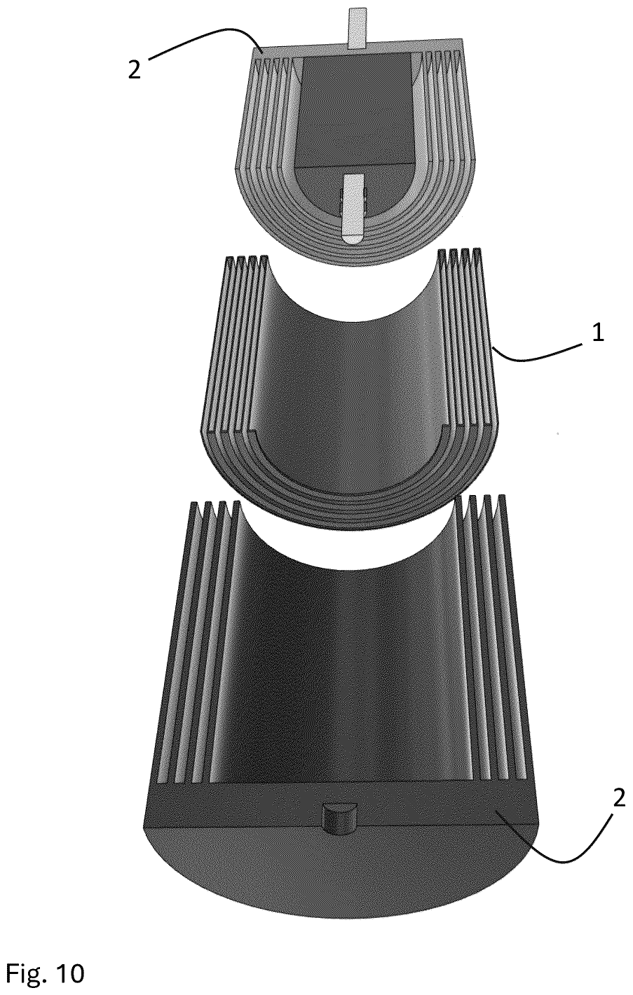

FIGS. 9-11 show other example embodiments of the present invention. In FIG. 9, an example structure of a stator 2 which includes concentric raised cylindrical magnetic members. FIG. 10 shows two of the stators 2 with concentric raised cylindrical magnetic members with a central rotor portion 1 provided therebetween.

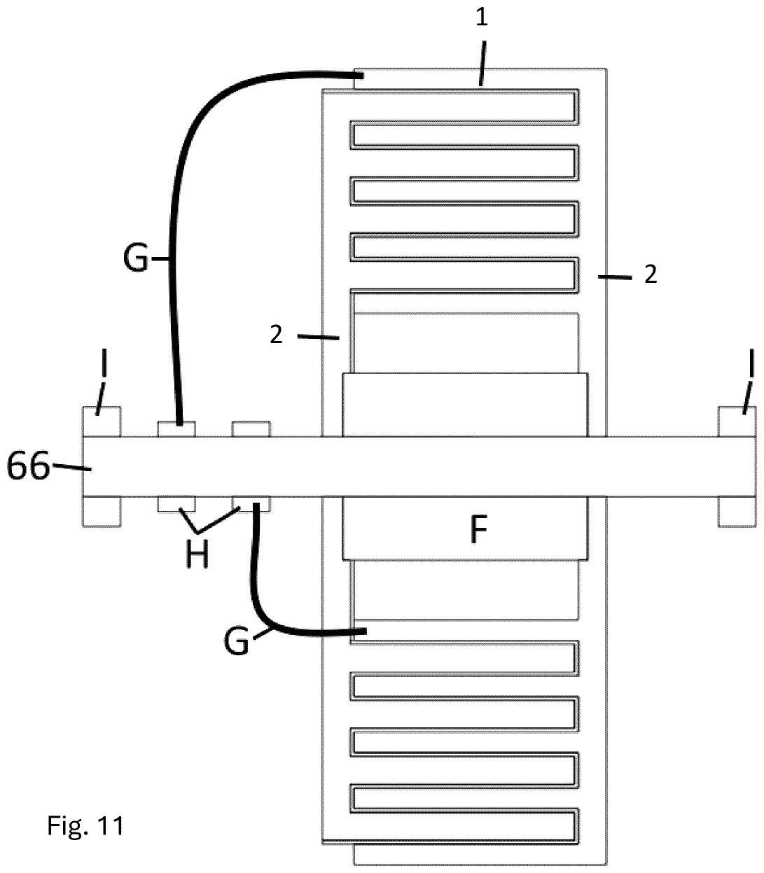

FIG. 11 shows that the example embodiments may further include This example embodiment includes an added axial shaft 66 and also shows example locations for bearings (I) connected to the axle. Note that it is preferred that the bearings (I) are positioned outside of the generator proper where the bearings (I) can be serviced or replaced more easily than in conventional designs. The current created in the rotor layers is collected via wires (G) and sent to, in this case, slip rings (H). Alternatives for the slip rings include conductive bearings, slip tubes described in disclosures related to this application, and example embodiments including contactless inductive ‘contacts.’ A ferrite core (F), for example, could be provided in the middle of the device for flux shaping.

Because the bearings (I) are associated, but not integral to the generator apparatus, the entire generator apparatus is essentially integral in that it spins as one single assembly. Preferably, none of the parts of the electromagnetic armature move relative to the others. The radial magnetic fields do not rotate as described above. The rotor layers rotate through the stationary radial magnetic flux, transecting the lines of flux at 90 degrees throughout both their longitudinal length and throughout the full 360 degrees of their rotation so current is efficiently induced to flow. The efficiency of this Lorenz function is higher than with all conventional generators. In this example embodiment the voltage of each layer is additive as the layers are connected in series.

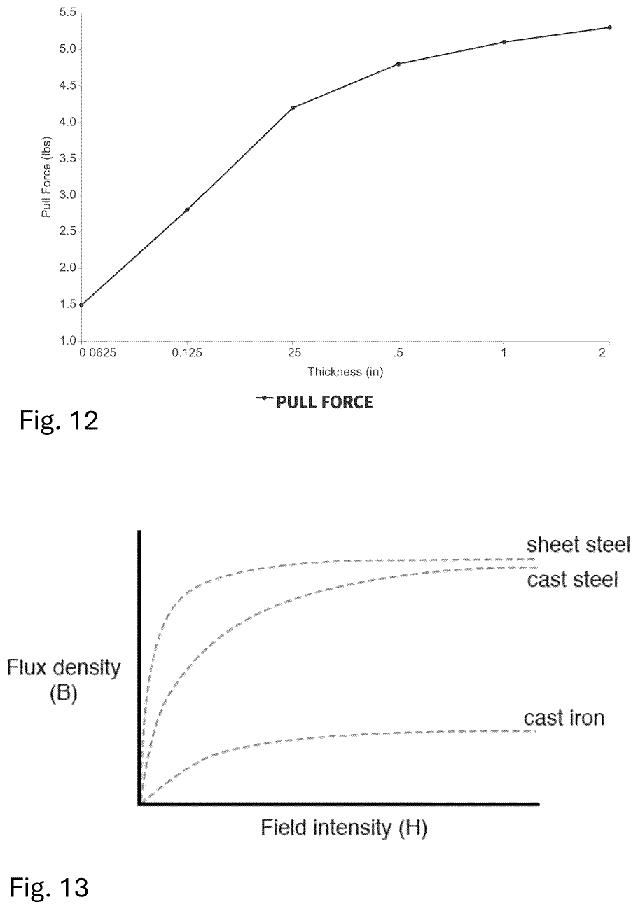

The magnets will be making an amount of total flux that, for the sake of this disclosure, will be called ‘down flux’. That total amount of down flux can be approximated from the average field intensity multiplied by the stator area. In the cylindrical design there is the complexity that the outer magnet layers have more flux and more area than the inner. This can be balanced in several ways, such as layer thickness, magnetization and material adjustments. For example, FIG. 12 shows that a pull force of a magnet changes based on the magnet's thickness.

The flux return system should be able to return more flux than the stator layer creates for several reasons. The first is to corral as much stray flux as possible and to limit its interference with the connections. Return flux intersecting the rotor connections creates reverse emf, canceling output. The second reason is to limit lateral interactions between the stator down flux and the return conduit up flux. The return path needs to be over engineered to be able to carry more flux because than is produced because as a material approaches saturation it takes more surrounding flux density to get the same amount more flux into the material.

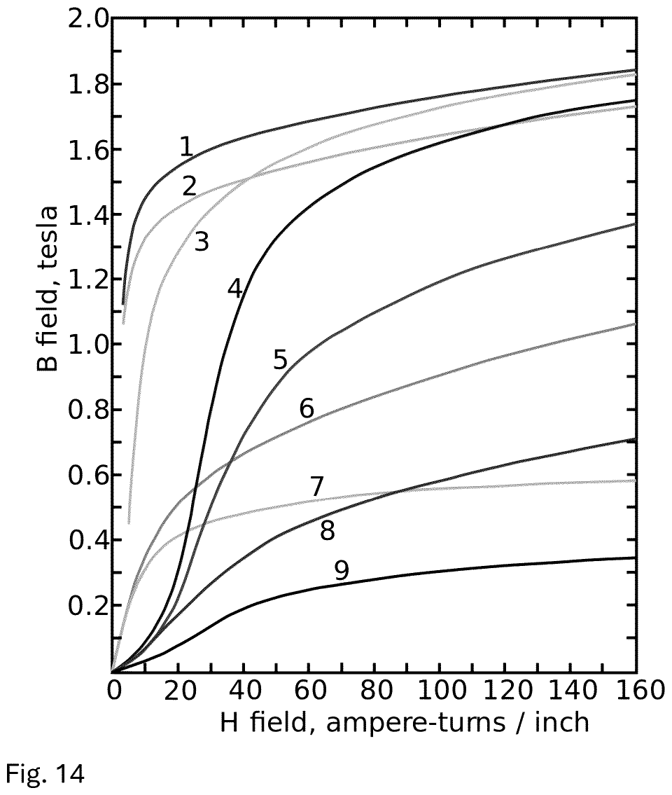

As shown in FIGS. 13 and 14, specific materials of the dynamoelectric machines of example embodiments of the present disclosure produce different flux densities (B) and field intensities (H). In FIG. 14, the following materials are show: (1) sheet steel, (2) silicon steel, (3) cast steel, (4) tungsten steel, (5) magnet steel, (6) bast iron, (7) nickel, (8) cobalt, and (9) magnetite.

If the up flux conduit has too low a capacity, the flux will cross over the connecting wires. If it has equal capacity there is a poor return. Additional material possibilities for use in example embodiments of the present invention are discussed below.

Permendur is a cobalt iron soft magnetic material (but a physically hard material) with among the highest saturation levels at 2.4 tesla. Adding vanadium makes it less hard/brittle and increases the coercivity. That is the V2 version. If it is formed grain oriented and has a few other trace elements it is Hyperco 50.

Metglass has an extremely high permeability of about a million, but saturates at 0.5 tesla.

Permalloy likewise has a high permeability (up to 200,000) but a seriously low saturation.

Nanoperm has a decent permeability at 80,000.

The saturation side speaks to the size needed to conduct flux which speaks to cost and rotor size and generator weight limitations.

Because of the nature of materials meaning saturation needing more H field to get more flux into the material, we need a relative excess of return flux capacity to keep as much of the percentage of return flux in the conduit, rather than as the B field which can be thought of in parallel to stray flux.

Equality in the flux return path, if we are talking about the “turbo” version wherein the flux return path is in itself magnetic, would be, if the return magnets were the same material and magnetic strength, an equal volume (cross sectional area) of magnets in the return path as in the rotor path. If there was excess rotor flux, it would overwhelm the return side as stray opposite flux possibly affecting the connectors. If there were excess capacity on the return side, and the metal/flux balance in the rotors favored the metal side, there would be a slight increase in the output. This would probably be offset to a degree by the extra cross sectional area need for the return conduits eroding rotor/stator area.

To offset the loss of rotor/stator area loss stronger magnets can be used for the return path, much like in the way a high permeability/saturation material for the purely conductive return path allows for less cross-sectional area.

In initial experiments with the magnetized flux return it was discovered by the inventor of the present disclosure that the magnets should not protrude past the flux return conduits which represent holes in the rotor area.

Soft ferrites are made with zinc, manganese nickel and the like. They can conduct, transmit or induce magnetic fields but don't magnetize permanently. They have good coercivity and poor remanence. They make good cores for electromagnets and transformers, but cannot make good permanent magnets.

Combining hard and soft magnets retains the high saturation magnetization of the soft material and the high coercivity of the hard one.

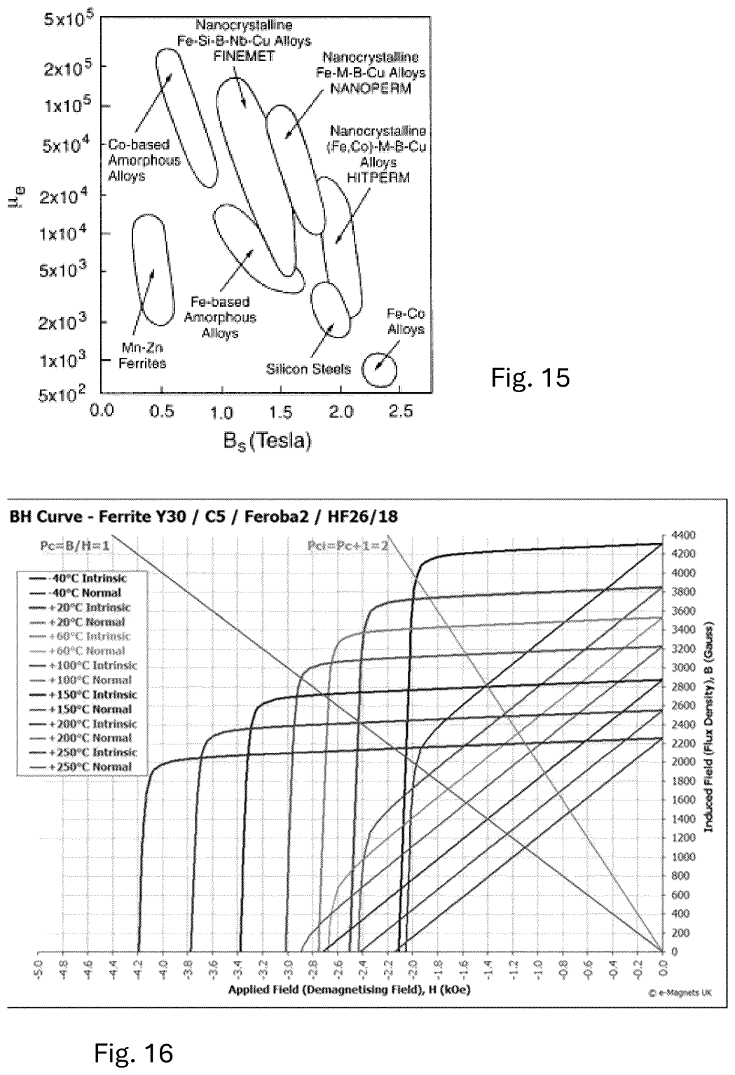

FIG. 15 shows examples of magnet materials which could be used in generating the stator field according to example embodiments of the present disclosure. It is noted that ferrimagnetic materials such as ferrite are poor electrical conductors, ferromagnetic materials such as iron are good conductors.

Neodymium makes about 10 times stronger a magnet than ferrite does, so it is ideal for generators and motors. There are neodymium versions that are about 13-17 times stronger. But neodymium is greater than equally more expensive (colloquially “flux per bucks”) and has serious bottlenecks to being mass production outside of China. Cost wise, it is important to realize that what is being bought is not a physical magnet, but a specific quantity of flux. Comparisons should be based on dollars per flux. In that case, the price is better for ferrite. This difference is more than made up by the cost savings of building a smaller overall generator if Neodymium is used over ferrite.

Ferrite, while a weaker magnet than neodymium does have some advantages. It has good resistance to demagnetization and can retain magnetism over a long time. Ferrite magnets can withstand higher temperatures, up to an outstanding 300 degrees Celsius as compared to 150 C for neodymium. They are also relatively inexpensive to produce from abundantly available materials. They are easily made and have a tremendous range of stock shapes and sizes. There is a moderate brittleness issue, but that is solvable with some standard engineering work.

An issue that is not well published but is of tremendous importance is that neodymium corrodes and ferrite does not. It is possible to coat neodymium to protect against corrosion, but the secret downfall comes to the fore when one thinks about an offshore generator plus anodization. Rust is a redox reaction, i.e., in iron, the Fe molecule oxides (gives up an electron) as part of bonding with oxygen to turn into one of many forms of iron oxide.

A neodymium magnet corrodes much faster than iron to begin with, even if it is just sitting on a counter. Let's call that corrosion rate ‘X″. X gets multiplied if the neodymium is attached to a metal that rusts less readily than it does. Generators/motors are made of such metals. Now realize that the accelerated corrosion rate X is proportional to the ratio of the amount of neodymium to the amount of other metals that are exposed. That is, X goes up proportionally if the ratio of the mass of other metal to neodymium goes up. It is an underestimate to say that a neodymium magnet in a large wind generator is attached to, say, 5 million times its weight of other metals, so the corrosion rate X is massive. In addition, the whole wind generator is mounted in a constant spray of salt water for offshore installations, and out in the rain for onshore which accelerates the corrosion process even more. One scratch in the coating of the neodymium magnet and the death-by-rapid-corrosion clock starts ticking for that magnet. The same is true for magnets in EV motors. Think of the proportion of weight of the magnet vs the weight of the iron in the car. Then think of all the water from wet roads and the salt on the northern roads all winter. The bottom line is that corrosion is a very important factor.

Ferrite, like iron, is not one thing. Starting with the broad categories, there are 2 kinds of barium ferrite (BaFe12O19 and BaO·6Fe2O3) and 2 types of Strontium ferrite (SrFe12O19 and SrO·6Fe203.) Interestingly, to make them, we start with iron rust of the Fe2O3 variety. The rust powder is simply mixed with either barium or strontium carbonate plus a dash of either cobalt or lanthanum. We do not use the barium option because, even though it is cheaper, the magnet isn't as strong or long lasting. Then we bake it away from oxygen at about 1000 to 1350 degrees C. This is called calcination or thermal decomposition, and it yields a metal oxide powder. We then mill that powder to an incredibly fine powder. In a best case, the particles are 2 micrometers in diameter so they only have a single magnetic domain each. (This is about 1/40th the diameter of a human hair, and talcum powder averages at 26 microns). Now we mix the powder in water to make a slurry paste and put it in a cylindrical mold, subjecting it to a radial magnet field that will make the domains all line up radially. Finally we compress and heat it so the water evaporates out and the powder sinters (fuses) into a solid, monolithic piece. This is one non-limiting example of how to make a ferrite magnet. We can then put the ferrite magnet back in the radial field and magnetize it to saturation. In general this takes 2.5 times the oersteds of the coercivity.

If the powder slurry is mixed with an additional powder of sufficiently high melting point, low remanence and magnetic conductivity, we can still do the last step and get a permanent magnet that is stronger but has the requisite additional permeability to conduct the electromagnetic flux.

Now we focus on neodymium. Sintered neodymium magnets are made by a somewhat similar process. First vacuum heat to melt a mixture of neodymium, iron, and boron (with a dash of praseodymium, dysprosium, aluminum, cobalt and/or niobium to help with physical properties like curie point). Cool and grind up the metallic lump in a jet mill into a fine powder of about 3 microns diameter. Unlike ferrite, the powder is then die pressed in 2 steps in different directions, again put in a mold, subjected to an external field to align the domains. Now it is demagnetized and it is pressed and heated to sinter it. Now it needs to be coated to stop the air from rusting it. The final step is to flash it with a very powerful field to magnetize it. The field needs to be 3 times stronger than the desired magnet strength. This is done with electromagnet coils powered by capacitor banks.

Bonded magnets are made by taking the magnetic powders, mixing them in a liquid polymer, injection molding, press molding or extruding it and letting them harden.

Bremags are bonded neodymium magnets but the neodymium dust can be made mixed with ferrite in the plastic binder so you get a hybrid magnet that is stronger than ferrite. They can be injection molded and over-molded bonded onto metal. They can handle the expansion differential and they are available as radially magnetized rings. I propose we mix in other ferro magnetic powders to increase the magnetic conductivity. The plastic binder would slow or stop the corrosion, stop brittleness, stop eddy currents, adhere to the metal stator and expand and contract elastically. It would make the magnet considerably weaker.

Most ferrite magnets are made by mixing iron oxide (rust as Fe2O3) (as opposed to magnetite Fe3O4) with either Strontium carbonate SrCO3 or Barium Carbonate BaCo3. Barium is less costly but the magnet is less strong.

The ratio is about 1:1.6 for the strontium mixture.

Adjuvants such as lanthanum or cobalt can be added to steer the magnetic properties.

The above mixture is cooked at 1000 to 1300 degrees C. in the absence of air in a process called calcination or thermal decomposition.

Calcination turns the mixture into a metal oxide, with a hexagonal molecular structure. There are 2 kinds of barium ferrite (BaFe12O19 and BaO·6Fe203) and 2 types of Strontium ferrite (SrFe12O19 and SrO·6Fe2O3.). The former strontium formula is the M type that is used most often.

The metal oxide is milled (rotated in a large drum with large hard metal balls) to grind it into a sub-micron powder. This is finer than talcum powder by about 1/40th. Jet milling can also be used to get super fine powders. This involves using high pressure air or gas to spin the powder.

The powder is then often press molded into the desired shape. Like everything, this can mean many things. Dry pressing makes an isotropic solid—i.e. it can be magnetized in any direction, but the magnet is weak and not as resistant to being demagnetized.

If it is wet pressed (mixed with water to make a slurry) we can put the mold in a magnetic field to get the hexagonal crystals to line up. This makes an anisotropic magnet (can be better magnetized in 1 direction than others). This is a stronger and more resilient magnet. Dry pressing gives a better shape that requires less grinding. The slurry can also be wet extruded, which is how arc magnets can be made.

Whichever process is used, they are now sintered-back in an oven to 1100-1300 C so the material fuses together more strongly and is more dense and less brittle. The finished product is called a green magnet and has little to no magnetism. They are machined, washed and dried and then subjected to a pulsed powerful B field that aligns to domains making them magnetic. This is usually done with electromagnet coils powered by capacitor banks, though it can be done with a Halbach array and other ways.

In this case, the pulse algorithm needs to be modified. The flash pulse that is most often used would induce eddy currents in the metal layers and disturb the B field making the magnet in-homogeneously magnetized. We need a radial field that starts out constant and just enough to align the crystals for radial anisotropy, then ramps up then down more gradually to avoid eddy currents.

Some soft magnetic material can be mixed in to have a permanent magnet that can conduct the flux of a second magnet such as an electromagnet, for the 3.0 version or just not magnetize it to saturation.

This is not difficult to do. All of it can be duplicated with homemade or reasonably readily available and modifiable machines.

There are various grades of ferrite that used to be named by American or UK conventions but the naming has been mostly taken over by the Chinese conventions as China has taken over nearly all the world's magnet production.

FIG. 16 shows a BH curve of Ferrite Y30. Regarding bonded magnets, Ferrite powders do not have to be pressed and sintered into a shape. They can be mixed with various polymers, and the polymer mixture can be molded, extruded or shaped, then magnetized.

For 3D printing the ferrite powders are mixed into acrylonitrile butadiene styrene and extruded into a filament. The filament is passed through what is essentially a motorized glue gun to shape the component. Then it is magnetized. While this is easy and cheap, and the magnet is somewhat flexible, the result has a high binder concentration so it is a weak magnet and it would take a lot to develop the needed anisotropy.

It is possible for ferrite to be doped with small amounts of neodymium, iron, and boron (perhaps with a dash of praseodymium, dysprosium, aluminum, cobalt and/or niobium to help with physical properties). This might increase the magnetic strength. The neodymium would need to be layered at the bottom.

Bonded magnets are made by taking the magnetic powders, mixing them with a polymer or elastomer, then injection molding, press molding or extruding it and letting them harden. Bonded Nd-magnets can be made by ‘melt spinning.’ A thin ribbon of the NdFeB alloy with randomly oriented Nd2Fe14B nano-scale grains is pulverized into particles, mixed with a polymer, and either compression molded into bonded magnets.

Bonded neo magnets can be made in other ways, also. But always Nd—Fe—B powder is bound in a matrix of a (usually thermoplastic) polymer to form the magnets. The magnetic alloy material is formed by splat quenching onto a water-cooled drum. This metal ribbon is crushed to a powder and then heat-treated to improve its coercivity. The powder is mixed with a polymer to form a moldable putty, similar to a glass-filled polymer. This is pelletized for storage and can later be shaped by injection molding. An external magnetic field is applied during the molding process, orienting the field of the completed magnet.

Bremags (Bunting Co) are bonded neodymium magnets but the neodymium dust can be made mixed with ferrite in the plastic binder so you get a hybrid magnet that is stronger than ferrite. They can be injection molded and over-molded bonded onto metal. They can handle the expansion differential and they are available as radially magnetized rings.

Neodymium magnets are electrically conductive which could be problematic due to eddy currents. Diluting the powder with non-conductive material such as ferrite and polylactic acids or other binders can resolve the issue, provided the ratios are sufficient to keep the neodymium particles from being electrically contiguous.

It is also possible to mix in other ferro magnetic powders to increase the magnetic conductivity. The plastic binder would slow or stop the corrosion, stop brittleness, adhere to the metal rotor and expand and contract elastically.

Bonded magnets and 3D printed magnets can largely be considered the same or very similar. In bonded ferrite magnets, about 15% to 30% of the material is the polymer binder, so the magnet is that percentage weaker. The percent additional dilution of the ferrite with neoadjuvant materials to increase permeability also subtract from the native magnetic strength by displacing the same volume of ferrite. This can be accepted or addressed, if wanted, by thickening the layer or adding a small percentage of neodymium. Because the amount of conductivity neoadjuvant needed is proportional to the permeability/susceptibility/saturation limit of that material or combination of materials' effectiveness, correct materials choices can limit the percentage magnetic strength loss. Another loss of magnetic strength comes from the ferrite particles being suspended embedded somewhat separately. The gaps between the particles limit flux conduction/permeability.

Typical Magnetic Properties of SrM magnets are as follows:
Magnet Type B˜(T) He—(kAlm)—(B·H.) max—KJ/m3
Sintered isotropic 0.20-0.23 136-152 6.4-8.4
Sintered Anisotropic 0.39-0.43 192-200 28.8-34.4 (High B)
Sintered Anisotropic 0.35-0.40 260-292 22.4-30.4 (High He)
Bonded Flexible 0.1-0.17 76-128 2.4-5.6 (Isotropic)
Bonded Flexible 0.20-0.25 140-176 8.0-12.0 (Anisotropic)
Bonded Rigid 0.13-0.14 72-84 2.8-3.2
Bonded Rigid 0.20-0.30 120-185 7.3-16.0 (Anisotropic)

Bonded magnets may have binders such as polymer or rubber binder or epoxy. Of course the magnetic component powder may be hard ferrite, Nd—Fe—B, Sm—Co, Sm—Fe—N, or, carefully arranged mixtures of hybrid magnetic powders because, for instance, neodymium will reorient ferrite fields, and also, electrical conductivity is, but may not have to be in some embodiments, preferably avoided.

Typical binders for flexible magnets are nitrile rubber and vinyl. Binders for rigid magnets include nylon, PPS, polyester, Teflon, and thermoset epoxies. The thermoplastic binders may be formed into sheets via calendering (which is, for example, rolling) or extrusion or formed into various complex shapes using injection molding, calendering, injection molding, extrusion, and compression bonding, as well as 3D printing.

Melt-spinning involves melting the alloy or elements in a crucible under vacuum or inert gas. The melt, under inert gas pressure, is sprayed through an orifice in the crucible onto a rotating, water-cooled copper wheel or disc. Cooling rates>1,000,000° C./see can be achieved which produces an alloy with an amorphous or fine grained nanocrystalline structure.

Calendering makes continuous magnet sheets and seems to be the best for our needs. A continuous roll of several hundred feet can be formed.

Neodymium magnets are primarily made with the alloy of neodymium, iron, and boron (NdFeB). Praseodymium (Pr), dysprosium (Dy), aluminum (Al), and niobium (Nb) may be added to enhance properties such as strength, temperature tolerance, and resistance to demagnetization and corrosion respectively.

The alloy is made by melting and mixing the neodymium, iron and boron in an air free furnace such as a vacuum induction furnace. The melted alloy is cooled by strip casting, a rapid cooling technique, resulting in thin flakes of the material. This probably adds an amorphous structure as opposed to crystalline structure.

These flakes are ground down and placed in a jet mill where they are pulverized into a fine powder. A jet mill uses high pressure air to spin and grind the powder.

Sintered neodymium magnets are made by vacuum heating the NdFeB (neodymium, iron, boron) mixture and casting it into a mold and cooled to form ingots. The ingots are ground into tiny grains and milled, typically in a jet mill. This fine powder is pressed into a shaped mold. After the crushed magnetic powder is put into the mold, an external magnetic field is applied for orientation. The powder is fully compacted after/during the orientation.

There are three methods used to press sintered NdFeB magnets, axial, transverse, and isostatic pressing. Each represents a particular relationship between the pressing axis and the magnetic alignment axis.

With axial pressing, the pressing and alignment axes are the same. Transverse pressing indicates that the pressing axis is perpendicular to the alignment axis. Finally, applying pressure equally from all directions is known as isostatic pressing. After the magnetic direction is locked, magnetized material is demagnetized. Because the material is too brittle for practical use, it must now be sintered. Sintering heats it in an oxygen free environment to near its melting point so that the magnetic particles fuse together.

After sintering, the magnet is quenched. The heated material is rapidly cooled, imbuing the material with greater strength and hardness. After the sintered magnet is quenched, a tempering treatment is performed to cool the magnetic powder.

Once it reaches the designated temperature it is reheated. The rapid cooling enhances the performance of the magnet by reducing the areas of poor magnetism.

The magnets can now be machined into their appropriate, useful shapes. Diamond plated cutting tools are used, due to the magnets' hardness. The machining methods include grinding and slicing, laser processing, and electrical discharge machining (EDM).

Iron Nitride magnets could be twice as strong as Ferrite and theoretically could optimize to 4 to 5 times armstrong ‘someday’. There are also thin film magnets.

Capacitive Discharge, DC Electro-Magnet, Half-Cycle and Permanent Magnet Magnetizing Systems can operate with energy capacities ranging from 100 Joules to over 100 kiloJoules.

When magnetizing a magnet, if it is done to its fullest potential, the material becomes magnetically saturated. This is a minor problem for some electro/permanent hybrid example embodiments of the present disclosure. If the permanent magnet is saturated, it acts like airspace separation between the electromagnet and its target, reducing the power by the 3rd order of the permanent magnet's thickness.

A magnetizing force required to saturate a magnet depends on the material's coercivity mainly, but its size and shape play a role. However, if the magnet is affixed to a conductor that presents a solvable problem. To saturate a magnet, one must apply a peak field of between 2 and 2.5 times the coercivity. For magnets attached to conductive base, as the magnetizing field propagates through the base, induced eddy currents set up a reverse magnetic field during the pulse. This reduces the net field the magnet experiences and can even change the magnetization direction. The other, simpler, solution is to make the magnetic strip un attached to the metal and combine them later.

Solving this involves making a longer time duration pulse. and/or changing the LC (inductance capacitance ratio) of the magnetizing circuit to extend the magnetizing pulse width, which is essentially the same thing. The longer the pulse the greater the heat though, so one solution begets another problem. That is easily solved though.

Bonded rare earth magnets are in a category of their own. The magnet powder is noncontiguous so it does not conduct flux as well and the binder acts as airspace, further weakening the field. The solution there is an even higher field strength (again, More heat) A good rule of thumb is 3× the HCl (intrinsic coercivity) is needed.

Below is a list of magnetizing fields needed for various materials.

Material Oersteds kA/m
Alnico 5, 6, 8 and 9 3,000-7,000 239-557
Ceramic (Hard Ferrite) 10,000-12,000 796-955
Neodymium-iron-boron, motor grade 35,000-50,000 2,790-3,980
Neodymium-iron-boron, high energy grade 30,000-40,000 2,390-3,180
Neodymium-iron-boron, most bonded 30,000-40,000 2,390-3,180
Neodymium-iron-boron, high temp bonded 35,000-60,000 2,790-4,780

The stator wall considerations: The inner stator needs to carry all the flux of the outer stator, but now concentrated into a smaller circumference. A basic rule of magnetism and the fundamentals of Maxwell's law include that flux lines cannot diverge or converge. The same “single line” exits and enters the magnet, and, indeed, passes through the magnet to form a closed loop. However, there are no lines. Lines are just a way to conceptualize something that is invisible and we have nothing else to compare to. A vector field is another valuable but equally flawed way to understand magnetism. Gradient force potentials densities are another. If we are going to use lines, always keep in mind that the lines are just the cut edges of a curved 3D rounded form.

The inner stator net permeability needs to be greater than the outer in proportion to their diameters, because the same number of lines (indeed the same lines themselves) pass through both the inner and outer stator walls. So if we are maxing everything out, and the outer stator can carry more flux because it has more cross sectional area to do it in, what do we need to do that isn't decreasing the flux in the outer stator?

The inventor of the current disclosure discovered that the first step is to just make the wall of the inner stator thicker than the outer one in proportion to the ratios of their diameter. That way their cross sectional areas are the same. Plus, keep in mind that the stator end near the coil, carries all the flux, but the flux load decreases as we move out the stator because some crosses the inter-stator gap. The thicker an inner stator is, the less room there is for the rotors, which, being the parts that make the power, are a fundamental variable controlling power density. Yes, there is so much power density that we could sacrifice some, but why do that when there are other solutions.

A better solution comes from separating out the jobs of the stators into separate categories and defining the materials that provide the ability to do those individual jobs. Basically the wall becomes a layered apparatus. First job is simple: rigidity. The stators cannot be allowed to dent, bend or flex in a system with the tolerances we need. We also need to be aware of brittleness, young's modulus, thermal expansion, corrosion, anodization, ductility etc. Steel may be considered because it is hard, cheap, easy to get in the forms we need.

The next job of the stator wall is to conduct magnetism from the coils. (Also see the section on coils as it affects this) Steel is not one thing. It is about 100 or more different but similar metals. Austenitic stainless steel has a terrible relative magnetic permeability (mu) of about 1. Martinistic can be about 10. The best, low carbon mild steel can be about 1000. Silicon steel is about 4000-5000, it is relatively cheap and available and probably the best deal if we are thinking of permeability per dollar, as we should, rather than price per lb., etc. So NO steel unless it is silicon steel. Other materials can be used, for example, iron.

There are many different varieties of iron, about 100 different products, all with different characteristics. The most important to the example embodiment of this disclosure is pure iron. Pure iron is at least about 99.95% or more. that gives us a permeability up to 100,000-200,000. Unfortunately, it is very expensive because there are very few current applications and everything is custom made. It may cost more than a thousand dollars to make a cylinder the desired size.

Mu metal (which also is many different actual metals including permalloy and supermaloy) has a relative permeability that is just amazing. It can be as high as 1 million, but its market conditions are even worse as far as price distortion. It is used in magnetic shielding mostly in small parts and in hard drives. The materials in it are cheap (80% nickel, 20% iron, and possibly a few trace metals like molybdenum), mixing and smelting it is not esoteric either. It needs to be annealed to get the high permeability, but that isn't hard either. Just heat it to about 600 degrees in an inert or reducing atmosphere for 3-6 hours then let it cool very slowly. Yet because so little of it is sold per year and in small quantities from just a few suppliers.

But suppliers and cost of manufacturing make this a challenge. This material can be bought in annealed sheets thin enough to bend uniformly and thick enough to be springy enough to allow it to be used as liners for stators in example embodiments of the present disclosure. This is much less expensive as a stocked item.

However, the welded seam may be less magnetically permeable and make a linear weak spot in the field that would allow eddy backflow. That backflow could severely limit the power of generators and motors of example embodiments of the present disclosure. Not just the seam itself, but the weld material and the heat affected zone also would be possible weak areas. Cutting it so the seam was a spiral wouldn't really solve that. Overlapping the seam might. Ultrasonic welding might. In other welding, there is a process called normalization wherein the whole thing is heated and cooled together to make the weld more homogenous with the other material. It relieves strain and might smooth over some of the permeability weak spot issue. But remember annealing? It is basically the same thing. It could be possible to buy the less expensive un-annealed sheet of mu metal, weld it, then normalize and anneal it later in 1 step. Even better, it is possible to buy sheets big enough to ring the silicon steel with a couple of continuous layers. The elasticity would push it out. It would be good to then inflate a tough ballon or other expansion device in there to seat it and then put in a few scattered spot welds. Another great option to consider is the mu metal can be deposited via sputtering, CVD<PVD<3D printing and the like.

Currently, it appears that example embodiments of the present disclosure start with a silicon steel cylinder for the best rigidity component when also factoring in price, availability, off the shelf stock and of course avoiding permeability bottle necks. Then it is sleeved it with Mu metal on the rotor facing side. Now we have a stator that is less expensive and carries sufficient permeability.

The third function of a stator is not just conducting magnetism, but also providing it. Ferrite is now a 3D printable/deposit able material. Strontium ferrite and barium ferrite are the two most commonly used forms. The strontium variant magnets have better magnetic stability. Bremags might be better than ferrite.

The ferrite can be deposited or glued on the outside of the silicon steel. Ferrite is hard, but brittle, so the silicon steel will protect it. It will have the yoke on one side and the silicon steel of the stator on the other, so its brittleness is not much of a concern. The bonding decision will have to be from awareness of the coefficient of expansion, so the might do better as a separately made part and sleeved after with an appropriately flexible glue. The ferrite layer is then radially magnetized. On the anti-rotor side of the ferrite is the yoke. The yoke needs to have enough permeability and/or thickness to conduct the anti-rotor side flux in a flux return path around to the other stator. It is possible that the ferrite is on the inner, outer or both stators. That is a whole page in itself. If it is on the outer stator it gives a lot of extra magnetic force, but now the inner stator needs even more permeability enhancement to carry all that bigger magnets flux, plus the electromagnet's flux. But that is a good problem to have if it is solvable.

Putting it on both stators can be sort of good in that it makes the field stronger in that both sides also power the opposite stator with their return flux. (it is always possible to make the single layer thicker), but there needs to be a way to connect the externally transmitted flux back to the internal mu metal layer. Don't forget that if the return flux path is on the anti-rotor side, the ferrite will act as a poor conductor of the flux as it is near saturation from its own magnetization. This bears a lot of consideration, but for now let's say the ferrite is on the outside of the silicon steel layer of the larger stator only. This has the possible additional advantage of less yoke needed on the inner stator.

Next comes the stator considerations from the electromagnets. In this sixth iteration, instead of ringing the stator's circumference with a lot of small electromagnetic coils, the inventor of the present disclosure made one big coil per rotor in the base, structured so North flux flowed into one stator and South flux flowed into the other. This elegant design was simple and reduced cost, size and complexity considerably. The rotor was made very thick on purpose, in part because a hugely powerful coil could be put in the coil chamber and produce big output numbers. There would not be a ceiling on the output from having more field than rotor metal, so whichever metal combination gave the highest output, was the right choice. If the rotors were thin, the ceiling would be when the metal got saturated relative to the field strength.

The problem was that the very powerful magnet coil made a massive excess of flux, but 2 things happened so the flux didn't make as strong a radial field as desired.

The flux had to leave the coil in only the cross sectional area of the thin stator walls. There simply was not enough metal, and the metal had too low a permeability to carry it. This was particularly limiting on the smaller inner stators at their base. That became the serious bottle neck. The metal was saturated even at lower coil power, massively throttling the amount of flux that could get out of the coil.

Then came the second problem, Which is referred to as flux dilution or flux diffusion. The flux that made it through the small cross-sectional area of the smaller stator, now spread across the entire surface area of the ID of the massively larger outer stator diluting it several hundred fold, i.e., only the flux that got through the small cross sectional area of the thin and small ring of the inner stator at the coil, spread out ultimately to the entire surface area of the inner diameter of the outer stator. This was maybe 100 times bigger so 2 orders of magnitude of flux density was lost.

At first the inventor believed it was a coil issue and modified the coil, making it many times more powerful. Still though, the field intensity wouldn't go above a paltry 75 milliteslas. There must have been a lot of flux to start with, if after the bottleneck and roughly 100 fold dilution we still have 75 milliteslas bridging a 37 millimeter air gap. Unfortunately the probe wouldn't fit in the ½ mm air gap when the rotor was in place to give us a gap measurement, but working back from 36 mm gap to 1 mm gap means if the rotor was a theoretically maximally permeable material the gap field would have been 32,000 times greater. (8 times greater for each of the 5 times you cut 36 in half until you get to 1)

If the rotor and air gaps together were 19 mm instead of 36 mm, the field would have been 600 milliteslas. If the rotor and 2 air gaps had been 11 mm the field would have been 4.8 tesla.

It is possible to: 1) anneal the series 6 prototype to increase its permeability, it is already known that this would work, but not a lot, 2) it is possible to add mu metal to the stators, 3) it is possible to shim out the thickness of the middle stator, and 4) thin down the rotor to get massive output numbers.

It is desirable to solve for both the flux dilution and the flux bottle neck. The latter is solved by making the bases or the Stators thicker and with more permeable layers, as well as decreasing the length of the rotor. There are alternative solutions such as a second coil at the top, or going back to the external coils. Not necessarily fully, but just enough to bypass the bottleneck if thickness and better permeability isn't sufficient. The ferrite's contribution is probably enough that we don't have to worry about the external coils.

There is much more to consider. For example, silicon steel is iron mixed with 8-10 silicon and a bit of carbon. Mu metal is mostly just iron and nickel which begs the question of if we add nickel to silicon steel, do we get an alloy closer to mu metal? If so then we have less layers in the wall.

As discussed before, because flux is a continuous loop, the inner stator flux density is higher than the outer stators flux density because the outer stator has a larger circumference for the flux to spread out in. In the series six test article, the outer stator was 6 in diameter and the inner was 3.2 inches. therefore the outer stator had roughly half the flux density as the inner. This circumference will be called ratio flux dilution.

Additionally, as one measures axially away from the coil, the inter wall flux density drops with distance because some of the flux closer to the coil has already taken the shorter path back across the rotor space and a smaller amount extends further in the wall before taking the trip across and back. So the flux concentration is highest in either stator just next to the coil.

The other, bigger, flux dilution issue is that the inner stator had a wall thickness of 0.28 inches and therefore a cross sectional area of 2.57 square inches in which to transmit all the flux that spreads out over the entire 112.5 inner surface area of the outer rotor. Therefore the flux concentration entering the small stator is 43.8 times greater than the flux density at the inner surface of the larger stator. This is a serious bottleneck, but there are many ways to fix the problem. Moreover the acuteness of the bottleneck is actually an advantage in that, it is the only part that needs fixing. i.e., if a more expensive material is needed, it will only need to go in the smaller stator, not the bigger one, and only towards the coil end, lowering cost.

Some of the ways of fixing the bottle neck include:
1) Make the inner stator thicker, especially toward the coil end.
2) Make the inner stator, especially toward the coil end more permeable by making it with different materials such as mu metal.

Up until relative magnetic permeability has been used euphemistically as an approximation of a concept that is not prioritized in motor/generator physics that I will call material ‘magnetic conductivity.’ Permeability is akin to one dimension of ‘magnetic conductivity’ but not the whole story. The next dimension is a metal's saturation limit. Mu metal has an extremely high permeability of up to a million, but a surprisingly low saturation limit of about 1.6 tesla. So while it can be thought to draw the H field readily into its internal B field, it levels off flat when the B field reaches 1.6 T even though the H goes higher.

So a material with a high permeability and a high saturation is preferred. the magnetic susceptibility, the unitless, similar, but different ratio of magnetism induced in a metal divided by the H field also needs to be considered. Susceptibility related to permeability as relative mu minus 1.

The bottom line is that in order to conduct the magnetic field needed, the stator needs to have high permeability, high saturation, and high susceptibility.

Steel has a low susceptibility, a low permeability and a high saturation. So unless my understanding is starting to blur (entirely possible) the limits of steel in conducting the force we want can be overcome by increasing the volume, or cross sectional area of the steel. It all gets slightly more blurred when we think about flux concentrating at the surfaces somewhat like the skin effect of electrons.

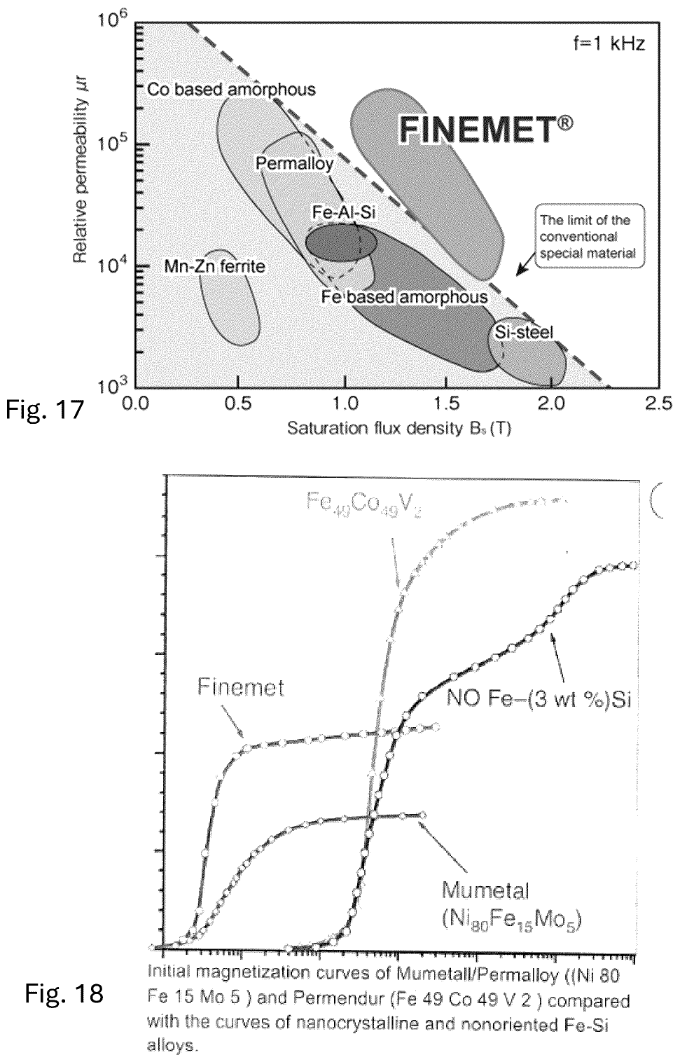

Trying to take it from the esoteric physics to the practical materials choices, FIG. 17 shows that in general the is a choice of high saturation such as silicon steel or high permeability of the mu metals. (Side note, Mu metal is just a brand name of one of a great many nickel iron alloys with similar properties. and there is a class of alloys called cobalt/vanadium with similar/better permeability) Plus there are the finemet variants that seem to beat all other options.

Finemet seems to be enjoying increasing market share in the high performance transformer industry but is a little more expensive. See, for example “High performance of low cost soft magnetic materials” Bull. Mater. Sci., Vol. 34, No. 7. December 2011, pp. 1407-1413.

The motor and generator industry mostly uses silicon steel because of cost, low electrical conductivity and high saturation. We could have added that the base of a small stator according to example embodiments of the present disclosure and multiplied their output. Exploration of combinations of materials is desired because there are going to be cost effective, advantageous mixtures. It seems possible that layering different materials or embedding them might give the best dollar weighted advantage.

Back to the other ways of solving the bottle neck.
3) Changing the coil to the middle of the rotor space and having 2 half rotors on each side, bears at least some thought as it might have a few other advantages.
4) Putting a secondary coil on the other end bears investigating.
5) Offloading some of the main coil function to smaller coils on the periphery of the stator as in the early drawings and early prototypes, not a lot, but a small fraction so that some of the fluxes being made in the stator walls and not flowing through the bottleneck.
6) The above is just one of the pure ac structures, but dc structures should also be considered because of the free flux of permanent magnets. If the stator wall has a magnetized ferrite layer providing a base field, that is flux that does not have to be made by the coil and does not flow through the bottleneck decongesting it sufficiently so inexpensive versions of the above are enough.
7+8) And of course, as the overall diameter increases the percentage difference in the stator circumference decreases, so to a significant degree, the next iteration will have much less bottle neck. The same is true as we make thinner walled rotors.

As discussed before, because flux is a continuous loop, the inner stator flux density is higher than the outer stators flux density because the outer stator has a larger circumference for the flux to spread out in. In the series six test article, the outer stator was 6 in diameter and the inner was 3.2 inches. Therefore, the outer stator had roughly half the flux density as the inner. This will be referred to as the circumference ratio flux dilution.

Additionally, as one measures axially away from the coil, the inter wall flux density drops with distance because some of the flux closer to the coil has already taken the shorter path back across the rotor space and a smaller amount extends further in the wall before taking the trip across and back. So the flux concentration is highest in either stator just next to the coil.

The other, bigger, flux dilution issue is that the inner stator had a wall thickness of 0.28 inches and therefore a cross sectional area of 2.57 square inches in which to transmit all the flux that spreads out over the entire 112.5 inner surface area of the outer rotor. Therefore the flux concentration entering the small stator is 43.8 times greater than the flux density at the inner surface of the larger stator. This is a serious bottleneck, but there are many ways to fix the problem. Moreover the acuteness of the bottleneck is actually an advantage in that, it is the only part that needs fixing. i.e., if more expensive material is needed, it will only need to go in the smaller stator, not the bigger one, and only towards the coil end, lowering cost.

Some of the ways of fixing the bottle neck include:
1) Make the inner stator thicker, especially toward the coil end.
2) Make the inner stator, esp. toward the coil end more permeable by making it with different materials such as mu metal.

Next will be a discussion of materials choices before going on to the 3rd enhancement. Up till now relative magnetic permeability has been used euphemistically as an approximation of a concept that is not prioritized in motor/generator physics that will be called material “magnetic conductivity.” Permeability is akin to one dimension of “magnetic conductivity” but is not the entire story. The next dimension is a metal's saturation limit. Mu metal has an extremely high permeability of up to a million, but a surprisingly low saturation limit of about 1.6 tesla. So while it can be thought to draw the H field readily into its internal B field, it levels off flat when the B field reaches 1.6 T even though the H goes higher.

So a material with a high permeability and a high saturation is needed. The magnetic susceptibility, the unitless, similar, but different ratio of magnetism induced in a metal divided by the H field also needs to be considered.

Susceptibility is related to permeability as relative mu minus 1. In order to conduct the magnetic field used in example embodiments of the present disclosure, the stator needs to have high permeability, high saturation, and high susceptibility.

Steel has a low susceptibility, a low permeability and a high saturation. So the limits of steel in conducting the force needed can be overcome by increasing the volume, or cross sectional area of the steel. It all gets slightly more blurred when we think about flux concentrating at the surfaces somewhat like the skin effect of electrons.

Going from the esoteric physics to the practical materials choices, we see in FIG. 17 that in general the is a choice of high saturation such as silicon steel or high permeability of the mu metals. Note that Mu metal is just a brand name of one of a great many nickel iron alloys with similar properties and there is a class of alloys called cobalt/vanadium with similar/better permeability. Plus there are the finemet variants that seem to beat all other options.

The motor and generator industry mostly uses silicon steel because of cost, low electrical conductivity and high saturation. This could have been added to the base of a small stator and multiplied the output of example embodiments of the present invention. It is desired to explore combinations of materials because there are going to be cost effective, advantageous mixtures. It seems possible that layering different materials or embedding them might give the best dollar weighted advantage.

The following description will be largely visual and has to do with material selection for enhancing rotor/stator/stator layer magnetic permeability/susceptibility/saturation limit. Cost and compatibility should be considered, but this should finish out the magnetic properties questions.

The imprecise term “conductivity” is used herein as a mishmash of permeability, saturation limit and susceptibility. Permeability can be thought of as how readily a substance takes in a magnet field. Saturation limit can be thought of as how much field that material can take in.

In FIG. 14, permeability is seen as how close to the y axis the initial rise of the curve is and the saturation is the point at which the curve levels off to a horizontal. Sheet steel has the best of both for the materials shown, however, saturating at less than 2 tesla is not great. These are the commonly available options. Now let's look at the more esoteric to see what is gained. Note that in FIG. 18 the Y axis goes higher and the axis is related, but different units:

Note that materials 1, 2 and 3 are already magnetized before the H field turns positive but that they saturate pretty much right at zero H. Permedur has the best saturation and 3rd best permeability. Amorphous boron steel (#4) has the best permeability and a pretty good saturation. In amorphous metals, the material is melted and then super rapidly cooled so the atoms don't have time to go into crystal latices. This takes the material out of the world of stock, off the shelf availability and into the expensive individual purpose built.

Permendur Co—Fe alloys are significantly less versatile and much more expensive due to the costly and socially/environmentally unfriendly cobalt. Permendur, Fe50Co50, has an unrivaled saturation of 2.45 T which is the highest value of all magnetic materials at room temperature. Adding 2% vanadium improves machinability and increases electrical resistivity, thus reducing eddy current losses, should those turn out to be important.

NiFeCo alloys called Perminvar (Not graphed) exhibit constant permeability across a wide field range but saturate at 1.5 T.

Grain oriented silicon steel is good, especially for the price. In general non grain oriented has been used in motors/generators, while grain oriented has been used in transformers. In example embodiments of the present invention, it is possible to use either or both.

Keeping in mind, the purpose of these recent investigations is to identify materials that could be combined to give the properties that each stator wall layer and the rotor needs most, then exclude those that are not combinable. In FIG. 18, Finemet saturates at about 1.2 T and flattens at 0.0 though so we can see that the large lines are 1 tesla on the y axis.

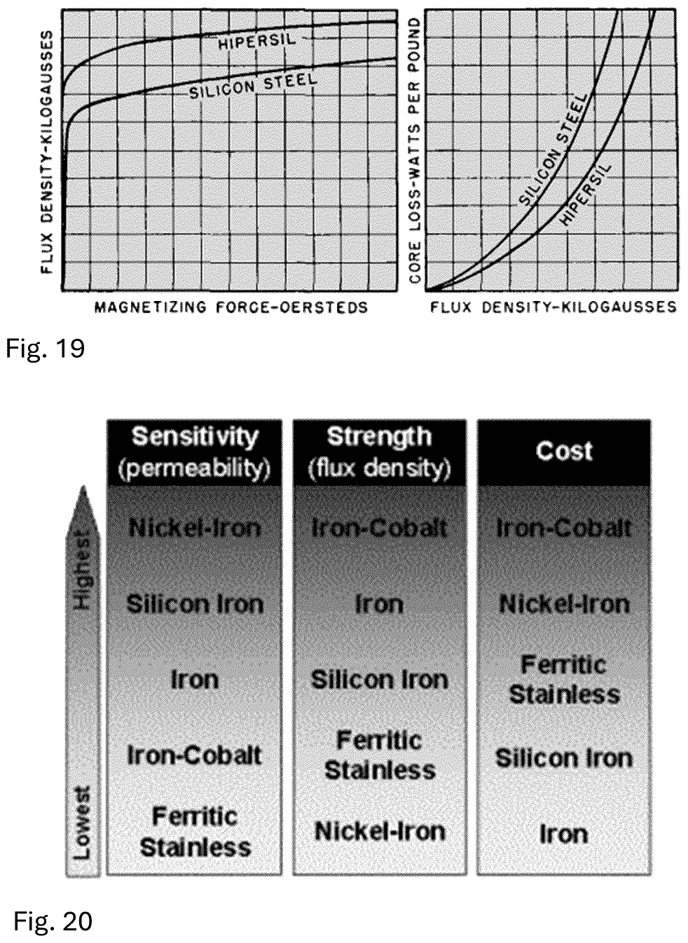

On the left in FIG. 19 is one form of grain oriented silicon steel called hipersteel, which gives about 15% more saturation limit than reg silicon steel.

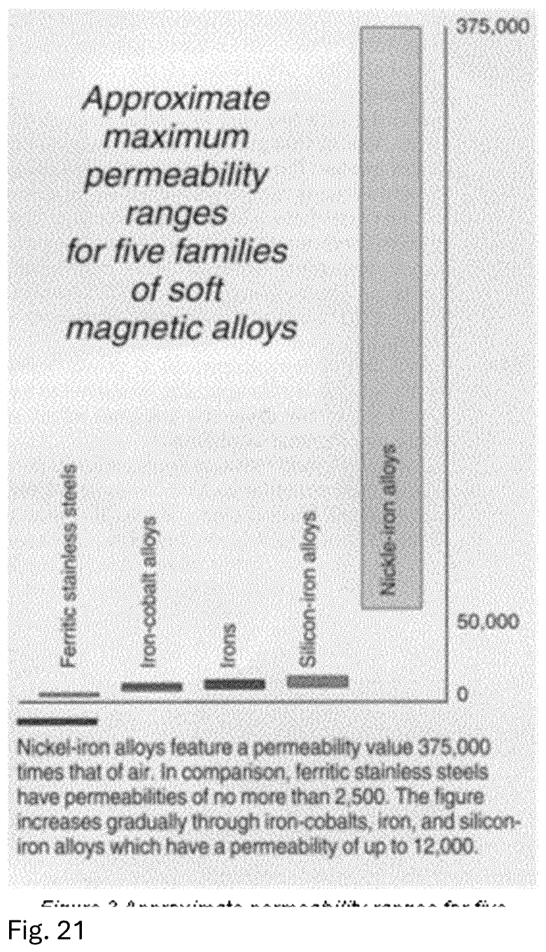

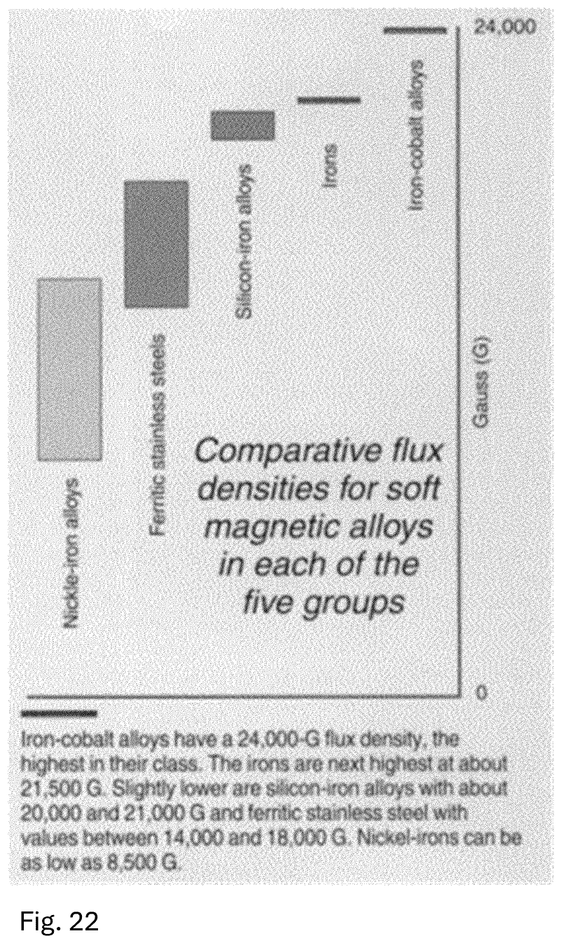

FIGS. 20-22 show another way of looking at materials choices.

There are many factors that determine the strength of an electromagnet. First is the number of wire turns and the amperage flowing through those turns. Voltage is only important in that it is what pushes the amperage through the coil, it does not directly affect the magnetism otherwise and therefore does not have a place in the calculations. If we multiply the Number of turns (N) by the amperage in those turns (I) we get the “magnomotive force.” Let's stick a ferro- or ferrimagnetic core in the center of the coil, extend the core in a circle of length L, broken by an airgap to create a simple model of the stators and look at the math of Ampere's law applied to this simple magnetic circuit. which, as usual, is the magnetic permeability of the core material.

Permeability changes with H field changes to make the saturation curve. If one wanted an exact measure, the hysteresis curve can give the correct value of mu at B, but if the coil is strong enough, one can just use the saturation value. Most common core materials saturate at a magnetomotive force of roughly 800 ampere-turns per meter of flux path. Also, the relative permeability of silicon steel is about 5000, so the part of the equation dealing with the core length is meaningless and can be excluded from the equation.

So the magnetomotive force is the field strength times the gap length divided by the permeability of what is in the gap. The field in the gap depends on how much magnetism it is subject to and the size of the gap and the permeability of what is in the gap. This is key when we discuss the rotor permeability enhancements. In example embodiments of the present invention, the airgap is not a simple cut in a core diameter sized loop. The cross sectional area of the metal leaving the coil expands to the surface area of the rotor facing stator's cylindrical wall, which is about a 40 fold increase in area and therefore represents a huge flux dilution before hitting the air gap. In an air gap of about 1.4 inches wide, a 0.09 tesla field is provided if the gap is filled with air. When we put a rotor in there of grey iron, the air gap is now (the 2 half mm airgaps=about 0.04 inches) plus (the thickness of the rotor wall. 1.36 inches (0.0345 METERS) divided by the relative permeability of the iron which might be 300 max).

We could stumble through the math backwards starting with an estimated permeability for the iron rotor, ductile steel inner stator and base and steel outer stator plus the airgaps to figure out the turns in the coil, but there are too many estimated variables to have that work out with any accuracy and the bottle neck being saturated messes up the math. In later iterations that will be possible.

For the flux tube, if we are using a single walled tube inside the coil, a large part of the magnetic field path is outside the core. The math is quite different in this case, because the poles are too far apart to consider that space an airgap.

The coil is affected by many other factors. Yes, amps and turns drive the magnetic force evolution, but amps depend on volts and the wire resistance. Recall the V=IXR and therefore I=V/R. Ignoring that wire can be made of metals other than copper, the primary factor is the diameter of the wire. The smaller the diameter of wire, the more turns can be fit in the same size coil and therefore, the stronger magnet. However, this is not correct.

The smaller the diameter of the wire, the greater its resistance. The greater the resistance, the less amperage that will flow through it. Also the longer the wire, the greater its resistance, so there are 2 factors that affect work against the increased number of turns. I have found a work around by dividing the coil into 3 separate wires that each have their own power supply for now. That way I know that my max stator field is being ceilinged by the bottleneck's saturation and not some other variable.

Initially, in example embodiments of the present disclosure, coils were separated into many coils stationed onto the circumference of the stator giving a radial field. In later example embodiments of the present disclosure, this was simplified into a single large coil, encased on 3 sides that pumped flux into the stators, but ran into the bottleneck of saturation inside the coil and at the base of the inner stator. Adding material in these places helps but not enough. Adding a mu metal layer also helps, but not enough. There are still saturation issues limiting the field. Even without that is the flux dilution issue as the flux that travels through the cross sectional area on the base of the inner stator and inside the coil spreads out over the entire stator cylindrical face. Shortening the stator would help but the longer the rotor, the higher the voltage it produces, all other factors being held equal. The field strength could be lowered, but that would lower power density and voltage. Offloading some of the flux to a permanent magnet layer and providing discreet flux return paths was considered. That may be enough, but we need to consider other ways to use the emags.

Neodymium is, on average, 2-7 times stronger a magnet than ferrite, so it is ideal for generators and motors. There is even a neodymium version that is about 13 times stronger. But neodymium is equally more expensive and has serious bottlenecks to mass production. Cost wise, it is important to realize that what is being bought is not a physical magnet, but a specific quantity of flux. Comparisons should be based on dollars per flux. In that case, the price is about the same. However, we need to be aware that the big generators use enough of the material to affect the supply demand curve. While this is not significant for Ferrite, neodymium requires rare earth material.

Ferrite, while a weaker magnet than neodymium does have some advantages. It has good resistance to demagnetization and can retain magnetism over a long time. Ferrites can withstand higher temperatures, up to an outstanding 300 degrees Celsius. Ferrites are also relatively inexpensive to produce from abundantly available materials. Ferrites are easily made and have a tremendous range of stock shapes and sizes. There is a moderate brittleness issue, but that is solvable with some standard engineering work. An issue that is not well published but is of tremendous importance is that neodymium corrodes and ferrite does not. We coat neodymium to protect against corrosion, but the secret downfall comes to the fore when one thinks about an offshore generator plus anodization. Rust is a redox reaction. i.e., in iron, the Fe molecule oxides (gives up an electron) as part of bonding with oxygen to turn into one of many forms of iron oxide. If we take iron and attach it to another metal that is more easily oxidized (for example, zinc) the zinc oxidizes first giving up the electrons that end up keeping the iron from giving away its electrons so it won't rust. The zinc oxidizes first keeping the iron from rusting. This is what galvanizing is all about. For example, metal trash cans don't rust because their zinc coating rusts, flooding them with electrons that keeps the iron from oxidizing.

The opposite occurs if we attach iron to a metal that is less likely to give up its electron, say aluminum (side note aluminum actually is a bit of a bad example because it actually oxidizes readily, but it is a good example because does so in a way that creates a coating to protect itself) I am using the example of aluminum because it is a classic industrial failure. In the past, popular SUVs were made with an aluminum body mounted on a steel frame. The aluminum anodized the steel and the frames all rotted to pieces.

Ferrite, like iron, is not one thing. Starting with the broad categories, there are 2 kinds of barium ferrite (BaFe12O19 and BaO·6Fe2O3) and 2 types of Strontium ferrite (SrFe12O19 and SrO·6Fe2O3.) Interestingly, to make them, we start with iron rust of the Fe2O3 variety. The rust powder is simply mixed with either barium or strontium carbonate plus a dash of either cobalt or lanthanum. Let's drop the barium option because, even though it is cheaper, the magnet isn't as strong or long lasting. Then we bake it away from oxygen at 1000-1350 degrees C. This is called calcination or thermal decomposition and it yields a metal oxide powder. We then mill that powder to an incredibly fine powder. The particles are 2 micron in diameter so they only have a single magnetic domain each. (This is about 1/40th the diameter of a human hair, and talcum powder averages at 26 microns). Now we mix the powder in water to make a slurry paste and put it in a cylindrical mold, subjecting it to a radial magnet field that will make the domains all line up radially. Finally we compress and heat it so the water evaporates out and the powder sinters (fuses) into a solid, monolithic piece. Thus a ferrite magnet is made. We can then put it back in the radial field and magnetize it to saturation.

If we skip this last step, we get a weaker magnet, but one that can conduct the extra flux from the electromagnet. I propose that if the powder slurry is mixed with an additional powder of sufficiently high melting point, low remanence and magnetic conductivity, we can still do the last step and get a permanent magnet that is stronger but has the requisite additional permeability to conduct the electromagnetic flux.

Now consider neodymium. Sintered neodymium magnets are made by a somewhat similar process. First vacuum heat to melt a mixture of neodymium, iron, and boron (with a dash of praseodymium, dysprosium, aluminum, cobalt and/or niobium to help with physical properties). Cool and grind up the metallic lump in a jet mill into a fine powder of about 3 microns diameter. Unlike ferrite, the powder is then die pressed in 2 steps in different directions, again put in a mold, subjected to an external field to align the domains. Now it is demagnetized and it is pressed and heated to sinter it. Now it needs to be coated to stop the air from rusting it. The final step is to flash it with a very powerful field to magnetize it. The field needs to be 3 times stronger than the desired magnet strength. This is done with electromagnet coils powered by capacitor banks.

Bonded magnets are made by taking the magnetic powders, mixing them in a liquid polymer, injection molding, press molding or extruding it and letting them harden.

Bremags are bonded neodymium magnets but the neodymium dust can be made mixed with ferrite in the plastic binder so you get a hybrid magnet that is stronger than ferrite. They can be injection molded and over-molded bonded onto metal. They can handle the expansion differential and they are available as radially magnetized rings. It would be possible to mix in other ferro magnetic powders to increase the magnetic conductivity. The plastic binder would slow or stop the corrosion, stop brittleness, adhere to the metal stator and expand and contract elastically.

Bonded magnets and 3D printed magnets can largely be considered the same. In bonded ferrite magnets, about 15% to 20% of the material is the polymer binder so the magnet is that percentage weaker. The percent additional dilution of the ferrite with neoadjuvant materials to increase permeability also subtract from the native magnetic strength by displacing the same volume of ferrite. This can be accepted or addressed, if wanted, by thickening the layer or adding a small percentage of neodymium. Because the amount of conductivity neoadjuvant needed is proportional to the permeability/susceptibility/saturation limit of that material or combination of materials' effectiveness, correct materials choices can limit the percentage magnetic strength loss.

Another thought is more metallurgical. Mu metals are roughly 80% nickel, 15% iron, and a small amount of molybdenum or similar material. Mu metals have high permeability (say 200,000) but a low saturation limit (1.6 tesla). Silicon steel, for example, contains 0.5%-8% silicon by weight with low carbon of less than 0.08% and the remainder is about 95% iron. This combination gives a relative permeability of about 4000, but a high saturation limit that can get into the low 2s. There has to be a way of combining these materials to add there advantageous properties, such as layering, embedding and alloying as well as some combination thereof.

Melting, mixing and alloying the powders would change the properties away from what we want in the same fashion that mixing several attractive colors of paint gives an ugly brown. So instead now we consider pulling out a bottle of, say, enamel/epoxy/poly acetate binder, mix well, and injection mold the slurry. On the plus side, each material retains its advantageous characteristic. On the negative side, the binder separates the materials so flux has to pass through the binder repeatedly to go from particle to particle wasting flux. Further, it's not just their presence of each material that is needed for the advantage, it is their location and cooperation. The ferrite gives permanent magnetism, but it needs a ferromagnetic metal yoke on the anti-rotor side to function as a flux return path. So we also amend the concoction by reducing the steel/silicon steel powder concentration and adding an anti-rotor side steel layer that starts on the anti-rotor side of the mostly ferrite layer to a second cylindrical layer on the other side of the rotor wall. The ferrite layer gives us????. Steel has the saturation limit but not the permeability, so we need to look into ameliorating it with the silicon steel and, vanadium, mu metals materials somehow. If we were to, however, sinter the mixture, the component with the lowest melting point would liquefy, while the higher melting point compounds would retain their shape and magnetic characteristics, we could have a monolithic structure that potentially combines all the advantages of its constituent materials. Also, the sintering process could be amended to include the annealing process into one operation.

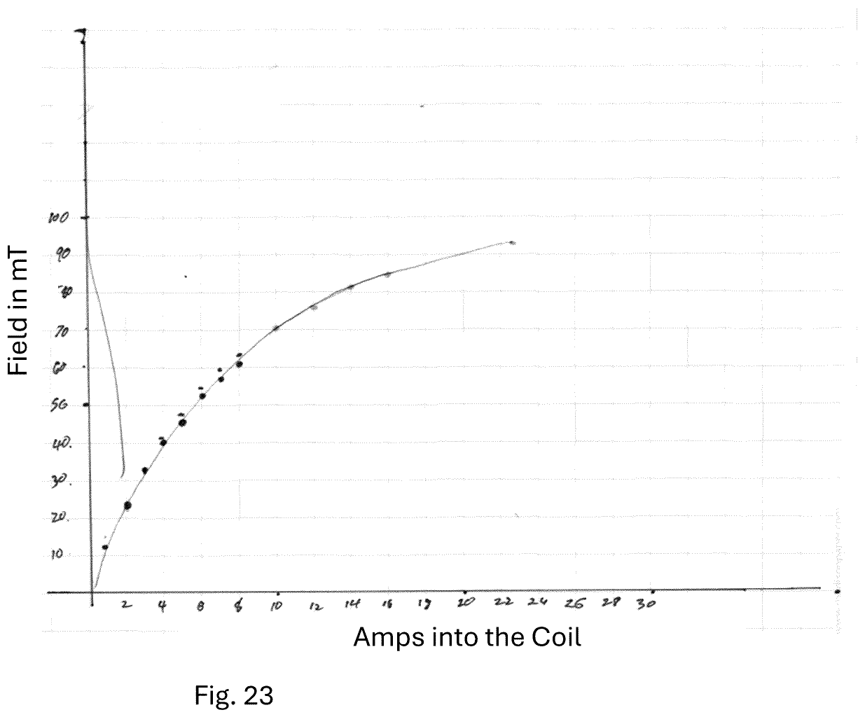

In a series 6 prototype corresponding to example embodiments of the present disclosure, a thicker mu metal was coated on the outer face of the middle stator. It works well and as expected, and the field, measured at 2.5 inches down from the upper lip, exactly mid-way in the 1.435 inch (oversized) rotor gap area is now 92 millitesla, or 0.09 tesla. Keep in mind the field is actually much stronger if the permeable rotors are in place, but we cannot test them without machining the rotors to increase the airgap. A field measuring sheet is shown in FIG. 23. In an example coil, there are 3 (18AWG) wires, each taking about 8.1 amps, each making about 3.7 ohms resistance which would put them each at 600 ft long, and making an estimated 500 turns each.

The idea of spinning the stators to avoid current collection losses is wrong. A magnetic field spins when the magnet rotates the axis between the poles such that the poles reverse sides, but not when the magnet rotates along that axis. The field does not spin, it acts more like a force than flux lines. The inventor of this disclosure is performing experimentation to see if it is possible to make the field spin by maybe etching the magnet face or covering it with a, say, checkerboard or starburst pattern of permeable/non permeable materials.

When combining materials, in which every material has its own laminated layer, i.e., we start with a silicon steel cylinder, upon which we deposited layers of other materials, such as vanadium/cobalt, finemet, Mu metal, steel, iron, silicon steel, ferrite. The following are examples of determining which layer goes where.

Ferrite is the layer with the most considerations. Ferrite provides magnetism but, 1) in its native form is magnetically saturated so it won't conduct emag force well, and 2) it is brittle so it is better off sandwiched between protective metallic layers.

Because it does not conduct e mag force well, it shouldn't be on the rotor side of the emag conducting layer.

Ferrite will need a flux path on both sides.

Therefore the emag flux conducting layer needs to be on the rotor side of the ferrite layer and will need to have a high enough permeability, and saturation limit to carry both fluxes. Keep in mind that the ferrite flux will be conducted radially through the thin wall, but the emag flux will be conducted longitudinally up the long axis of that layer. Conducting flux in 2 directions may be a little tricky.

The yoke should preferably be the most anti rotor layer and functions as a flux return path so it needs sufficient conductivity and saturation and rigidity. On the inner stators, it will be thicker walled than on the outer stators.

FIG. 23 shows a table and graph of the amps inputted into a recent coil of an example embodiment of the present disclosure and the rotor field intensity in milliTeslas. Without limiting factors there should be a 1 to 1 straight line but there is a classic diminishing return curve.

The results of FIG. 23 are following the shape expected. This is probably because there are different materials laid out in different parts. The base is ductile iron, the inner rotor is mu metal and either ductile iron that had been hardened before we got it or steel, but with a mu metal layer and the outer stator is steel.

Regardless, we see that the first amp adds 15 mt but subsequent ones add a diminishing benefit until the last amp adds only 2 millitesla. It is desired to consider how to take advantage of the non diminishing return side of the curve, or change the curve. As can be seen from the data sheet, it does not matter much whether the subsequent amps are added to the same coil or to another one. Thus, the issue is not the coil but the magnetic flux conduction.

One easy solution is to have the stators be made of stacked segment, each with its own coil.

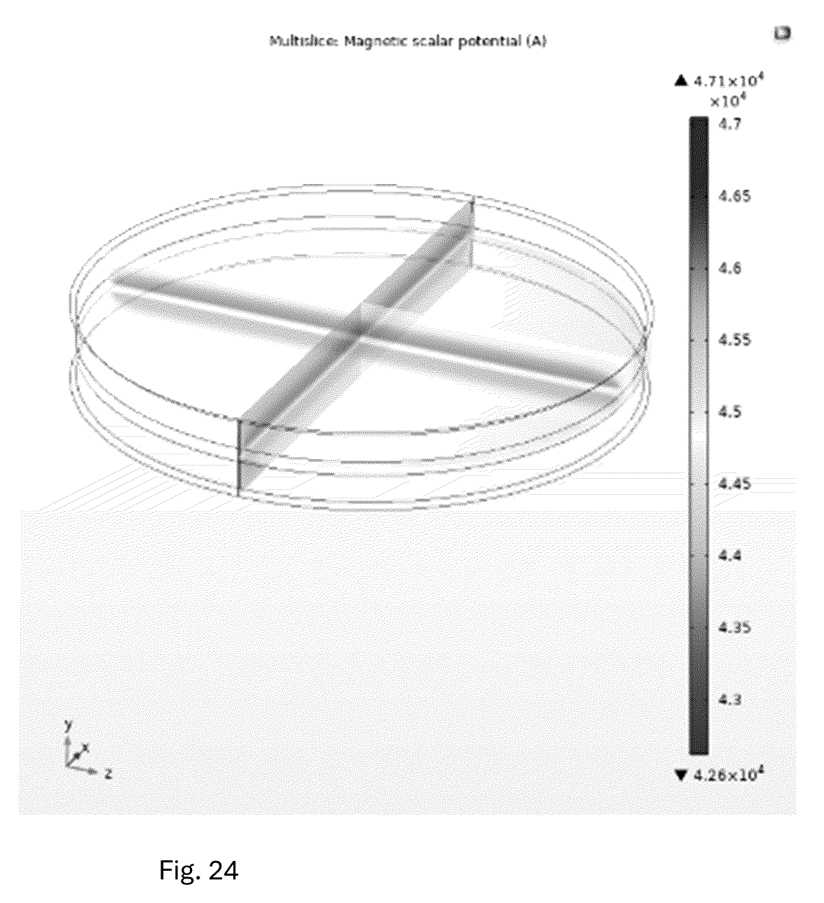

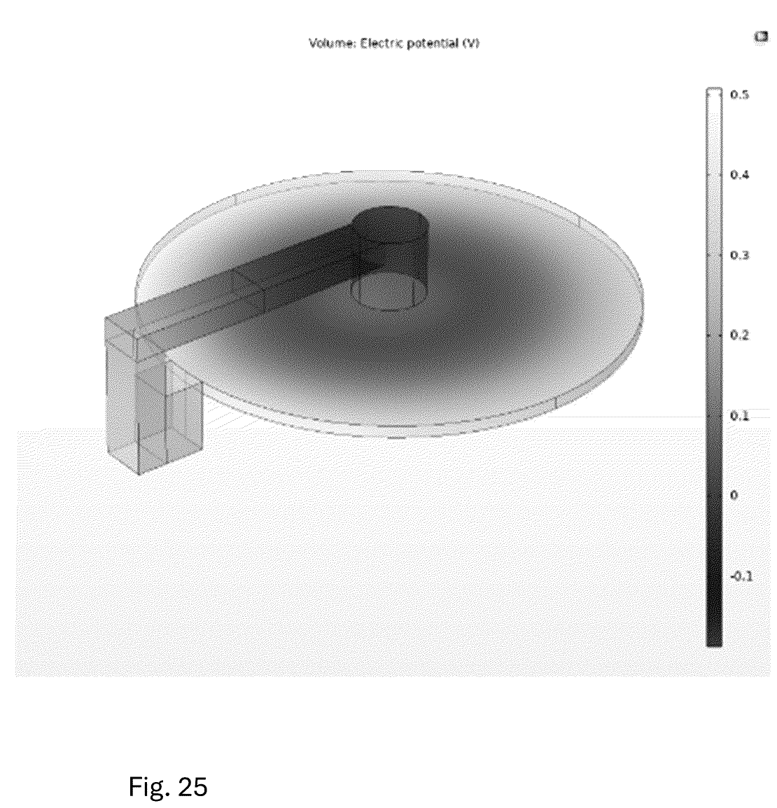

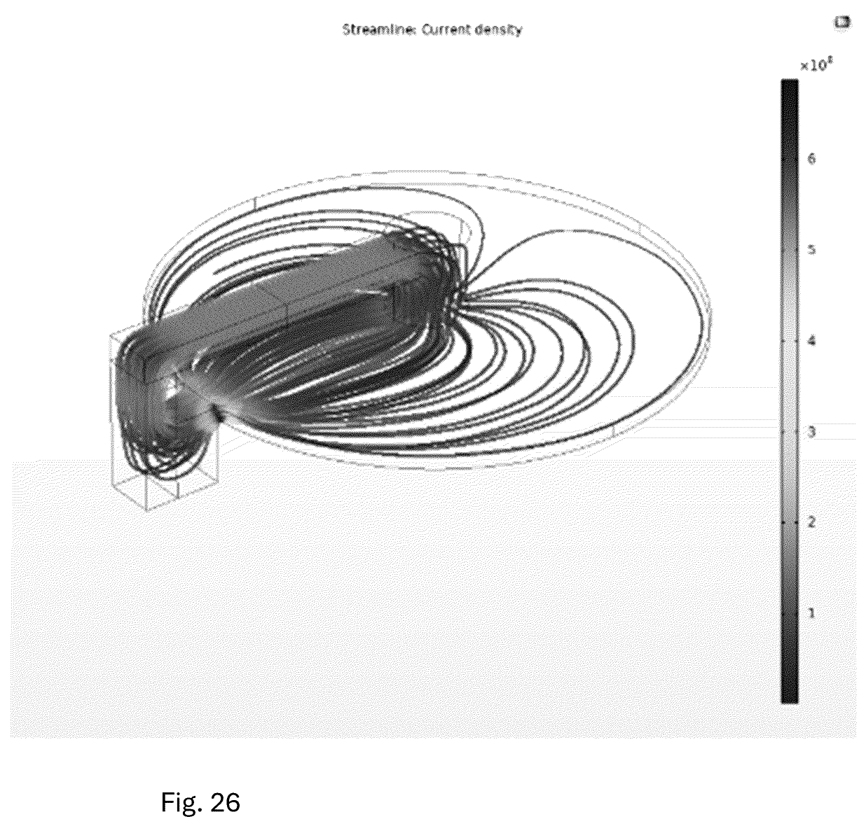

To make the results of the above-discussed prototype independently verifiable by commonly available FEA analysis, FIGS. 24-26 provide a COMSOL FEA analysis starting with a simple disk embodiment version rather than the higher specific energy drum embodiment. For the sake of simplicity a pure copper rotor variant data was used even though doing so adds weight to the rotors while reducing their output. Also, all multiple rotor layers were combined into one thick layer of the same material, proportion and total mass. Likewise, all magnet layers are combined into 2 thick magnets of identical mass, strength, and total distance separation. This makes the math comprehensible and the only change is that the field loses power, so results are again under what is achievable with my designs.

The multiple rotor layers can be considered as one disk that is 40 cm across and 1.5 cm tall. Considering them this way, instead of with the spread out, layered architecture vastly simplifies communication and changes nothing with regard to weight, output, and specific energy. The rotor volume is 1, 884 cc's with a mass of 16.88. kg.

Two N50 neodymium magnet disks with a 40 cm diameter and a combined 1 cm thickness plus a total of 5 mm thick flux return layer of the same diameter gives the 0.5 tesla field. The combined magnet volume is 1,256 cc's, with a mass of 9.42 kg. The flux return adds 3 kg.

Added ¼ kg for the miscellaneous, fasteners, adhesives, contacts, wire, and plastic, plus 3.75 kgs of stabilizing framing gives the total system mass of 33.272 kg. The bottom line is that generators based on the Faraday drum principles get rid of the weight of silicon steel, use a more powerful and effective field, have a much higher volumetric percent of electroactive rotor material, have ideal rotor/field interaction, and can fit more generating in the same space, creating a far greater specific power than conventional designs. They are generally more robust and simple and can have a very low parts count compared to conventional designs. They are simpler, easier and less costly to manufacture, and because they utilize their magnets so much more efficiently than conventional designs can more readily use non rare earth magnets than can conventional designs.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A homopolar dynamoelectric machine comprising:
stator layers spaced radially apart from one another to produce a magnetic field;
at least one rotor layer provided adjacent to the stator layers, and rotatable through the magnetic field; and
stationary contact rings located adjacent to two axial ends of the at least one rotor layer; wherein
the contact rings include angled contact portions or brushes to electrically contact the at least one rotor layer; and
bridge connectors are provided to electrically connect ones of the stationary contact rings axially opposed to one another.

2. The homopolar dynamoelectric machine according to claim 1, wherein the at least one rotor layer includes multiple rotor layers which are separated from one another.

3. The homopolar dynamoelectric machine according to claim 2, wherein ones of the multiple rotor layers are electrically connected to one other in at least one of series or parallel.

4. The homopolar dynamoelectric machine according to claim 2, wherein each of the multiple rotor layers include multiple portions defined by materials with different magnetic permeabilities.

5. The homopolar dynamoelectric machine according to claim 2, wherein the multiple rotor layers each include layers of copper and iron.

6. The homopolar dynamoelectric machine according to claim 1, wherein the rotor layers and the stator layers are integrally connected to rotate together about a central axis of the homopolar dynamoelectric machine.

7. The homopolar dynamoelectric machine according to claim 1, wherein
the stator layers and the at least one rotor layer define a first generator; and
additional stator layers and at least one additional rotor layer are provided in an empty center of a hollow tube housing the stator layers and the at least one rotor layer, the additional stator layers and the at least one additional rotor layer define a second generator.

8. The homopolar dynamoelectric machine according to claim 7, wherein
the second generator is structured to have an operating power generation range which peaks at a different RPM than that of the first generator.

9. The homopolar dynamoelectric machine according to claim 7, wherein
the second generator is structured to output power with an opposite polarity from power output by the first generator.

10. The homopolar dynamoelectric machine according to claim 1, wherein
four of the stator layers are provided;
the at least one rotor layer includes three rotor layers; and
three of the stationary contact rings are located adjacent to each of the two axial ends of the three rotor layers.

11. The homopolar dynamoelectric machine according to claim 1, wherein
the stator layers include permanent magnets to produce a fixed magnetic field; and
the at least one rotor layer includes a conductive portion that is rotatable through the fixed magnetic field to produce an electric current.

12. The homopolar dynamoelectric machine according to claim 11, wherein the permanent magnets are iron nitride magnets.

13. The homopolar dynamoelectric machine according to claim 1, wherein the stator layers are fixed to the at least one rotor layer.

14. The homopolar dynamoelectric machine according to claim 1, wherein a radially inner one of the stator layers has stronger magnetic properties than a radially outer one of the stator layers.

15. The homopolar dynamoelectric machine according to claim 1, wherein
the stator layers and the at least one rotor layer include groupings of stator and rotor portions;
the groupings of the stator and rotor portions are provided between support frames.

16. The homopolar dynamoelectric machine according to claim 15, wherein
at least one of the support frames includes cooling fins at a radially inner surface or a radially outer surface thereof.

17. The homopolar dynamoelectric machine according to claim 15, wherein
at least one of the support frames includes cooling channels extending axially therethrough.

18. The homopolar dynamoelectric machine according to claim 1, wherein
the at least one rotor layer includes multiple rotor layers with different axial dimensions.
